(19) United States
(12) Patent Application Publication
(10) Pub. No.: US 2017/0063827 A1
(43) Pub. Date: Mar. 2, 2017

(54) DATA OBFUSCATION METHOD AND SERVICE USING UNIQUE SEEDS

(71) Applicant: Richard Frederick Ricardo, Miami, FL (US)

(72) Inventor: Richard Frederick Ricardo, Miami, FL (US)

(21) Appl. No.: 15/246,139

(22) Filed: Aug. 24, 2016

Related U.S. Application Data
(60) Provisional application No. 62/209,294, filed on Aug. 24, 2015.

(51) Int. Cl. H04L 29/06

(52) U.S. Cl. CPC H04L 63/08; H04L 63/083; H04L 63/18

(57) ABSTRACT

Techniques for obfuscating and securely communicating data are described herein. In one example, a client device may be authenticated with a service, for example, by transmitting authentication information encrypted with an initial unique seed generated and provided by the service. The service, upon authenticating the client device, may generate at least one first unique seed including a corresponding random number that includes a randomly selected start value and step value. The service may encrypt the first seed and corresponding random number using the initial seed and communicate the encrypted first seed and the encrypted random number to the client device. The client device may subsequently transmit data to the service by encrypting the data with the at least one first unique seed and in some cases, with subsequent seeds, generated by the service, encrypted by the first seed, and communicated to the client device.

### CROSS REFERENCE TO RELATED APPLICATIONS

This application claims priority to U.S. Provisional Patent Application No. 62/209,294, filed Aug. 24, 2015, the content of which is incorporated herein by reference in its entirety.

### BACKGROUND

With improvements in memory and data storage technology and parallel increases in processing capability of computing devices, communication devices, and so on, larger amounts of data is being generated and transferred between devices. Resulting in part from increases in processing capability of these devices, data security, particularly relating to communication of various types of data, is becoming more difficult to ensure. Known encryption techniques are becoming easier to hack, and in turn, encryption techniques are becoming increasingly more complex, requiring more time and multiple communications between devices to implement. Known public key/private key techniques, while relatively secure, primarily based on the fact that it is infeasible to derive a given user's private key from a publicly accessible key, are not hack proof, and do not ensure that data being communicated will not be intercepted and/or manipulated by unwanted parties. Various problems and shortcomings of current encryption techniques are described in detail below.

Current safeguards and data security measures, such as user name and password schemes, terminal logins, biometrics, and common access cards (smart cards), are all susceptible to attack or failure. For example, these authentication and security systems may store authentication information in a location that may be susceptible to external attacks or internal malfeasance/human error. An attacker may access privileged information or physically access facilities using stolen credentials and gain un-authorized access to the privileged or protected data, communications, etc. With the advent of quantum computing (computing utilizing super positions instead of binary), known encryption techniques are becoming easier to hack and ultimately may become obsolete. Security systems stand vulnerable, with attackers having the ability to track your location, read your correspondence, and assume your digital identity.

Current ways to access data encryption services and the user interfaces that these services provide present a further barrier to data security in a cumbersome and often time-consuming user experience. Current encryption techniques are becoming increasingly more complex, requiring more time and multiple communications between devices to implement, further resulting in more time for a user to implement.

Another problem with current encryption and data security techniques involves data breaches caused by human error. With encryption techniques that rely on a user submitting encrypted data along with a decryption key, human errors may happen. Such errors may include accidently sending the decryption key to the wrong recipient, for example.

Another issue facing current data encryption solutions is difficulties associated with cross platform integration of encryption techniques. The use of HTTPS and SSL have helped in establishing a way for organizations with a web presence (e.g., banks, retailers etc.) to connect with users and customers in a secure way. However, this type of security, which may be in the form of a static token originating from a certifying authority, is prone to failure and has proven vulnerable to zero day weaknesses such as the Heartbleed Bug.

Another, related problem includes the inability to securely connect a user to content. For example, in connecting to a banking application, either through a desktop, laptop, or mobile device, private information is only secured point to point by the public PKI structure that the application or website uses to communicate over the Internet. As the keys and cipher seldom change, there exists the possibility in the future of other “zero day” attacks or unknown vulnerabilities opening up public cipher systems.

Cloud storage and email present yet more obstacles and issues to current encryption schemes. Many users depend on hosted email servers in the cloud that store email which has been deleted from the email client (via IMAP, POP3, etc.) for some predetermined period of time (if ever) before purging the data completely. The same situation occurs for cloud based storage systems such as Dropbox, Google docs, One Drive, etc. While the retention of such data may be useful in situations where the recovery of such information is deemed necessary, the benefits experienced by an average user associated with storing the “old” data may not outweigh the potential detriment if the security of the data is breached.

An additional problem faces by current data security solutions involves the inability to stop an individual or entity attempting to breach the security of data from trying different techniques until one is successful. This affords the ability to refine techniques for breaking or hacking the secured data.

### BRIEF DESCRIPTION OF DRAWINGS

The following detailed description may be better understood when read in conjunction with the appended drawings. For the purposes of illustration, various examples of aspects of the disclosure are shown in the drawings; however, the invention is not limited to the specific methods and instrumentalities disclosed.

FIG. 1 is a diagram illustrating an example system for establishing a secure communication link between a client device and a service in accordance with the present disclosure.

FIG. 2 is a diagram illustrating another example system for establishing a secure communication link between client device and a service in accordance with the present disclosure.

FIG. 3 is a diagram illustrating an example encryption pad in accordance with the present disclosure.

FIG. 4 illustrates a flow diagram of an example process for establishing a secure communication link between two devices and transferring data over the secure communication link in accordance with the present disclosure.

FIG. 5 is a diagram illustrating an example system for establishing a secure communication link between two devices using an intermediary service in accordance with the present disclosure.

FIG. 6 is a diagram illustrating another example for establishing a secure communication link between two devices using an intermediary service in accordance with the present disclosure.

FIG. 7 illustrates a flow diagram of another example process for establishing a secure communication link between two devices and transferring data over the secure communication link utilizing an intermediate device in accordance with the present disclosure.

FIG. 8 is a diagram illustrating another example system for establishing a secure communication link between two devices using an intermediary service and securely storing data in accordance with the present disclosure.

FIG. 9 is a diagram illustrating an organization architecture of a data security system in accordance with the present disclosure.

FIGS. 10A, 10B, and 10C illustrates an example system and process for establishing a secure communication link between two devices and transferring data over the secure communication link in accordance with the present disclosure.

FIGS. 11A, 11B, and 11C illustrate an example system and process for establishing a secure communication link with a data encryption service and securely storing data on a client server in accordance with the present disclosure.

FIGS. 12A and 12B illustrate a flowchart depicting an example process for establishing a secure communication link between a client device and a service in accordance with the disclosed techniques.

FIG. 13 illustrates a flowchart depicting an example process for transmitting and subsequently decrypting encrypted data received over a secure communication link in accordance with the disclosed techniques.

FIG. 14 is a diagram illustrating an example computing system that may be used in some embodiments.

### DETAILED DESCRIPTION

Systems and techniques for establishing a secure communication link between two or more devices using one or more seeds, which may address one or more problems noted above, are described herein. Encryption can be defined as a process of obfuscating contents or data of a message, for example, to prevent an interceptor or an unintended recipient from viewing the contents or data by way of an equation driven cypher. The process described herein is a modification to traditional techniques of encryption, primarily by not requiring the passing of math, keys, or any PKI structure. In one example, an encryption or secure data transfer service, for example hosted on a server, may generate a unique seed for obfuscating data to be communicated between devices. The service may include or be associated with a random number generator (RNG), such as a quantum or quasi-quantum random number generator (qRNG), that is configured to generate seeds of varying lengths for use in generating a transaction based, and in some cases, single use, identification system for the purposes of personal authentication for obfuscating data. In one aspect, the random number generator may be a hardware random number generator, such that seeds generated by the random number generator are unbreakable by mathematical models or analysis (e.g., based on quantum events). In one aspect, the number generated by the RNG may include a quasi-quantum randomly generated number (QQRGN), which may be a unique large binary number generated used to stamp or otherwise create a unique identifier to a value or group of values. The seed generated by the random number generator may be used to bit shift data non-sequentially. The transmission of data may include the generation of multiple strands for the purpose of the parallel processing of data. In some aspect, eight parallel processing threads may be used per byte of information, e.g., one thread per bit of information. The eight parallel processing threads may be used to parallel shift bits within a data stream, document, file, etc., based on the seed that is generated by the qRNG. Once a seed has been generated by the qRNG and used, it may be discarded and/or destroyed, to minimize the risk of an unwanted party gaining access to the obfuscated data.

In one aspect, a system for implementing the described techniques for data obfuscation may include multiple, cloud based servers. In some cases, there may be a server for the facilitation of sending documents or other data, and there may be a separate server for the purpose of authentication of an end user using a client device and the security of the data transmission. The authentication server may, in some instances, generate the seed that is used for obfuscating data as well as in the descrambling of information. After the generation of the seed (generated on a per-transaction basis), the data is manipulated on a per bit basis (1 thread per bit, 8 threads per byte) to the randomized, in a non-sequential order determined by the seed generated by the qRNG. In some aspects, the authentication server may not keep or store records of the seeds it generates, e.g., ‘key tables’ as in a standard encryption system, yet it maintains the ability to descramble previous communications via the techniques described in further detail below. Upon registration, or in instances after registration, authentication of submitted user information, the service may communicate a first unique seed including a first random number or Quantumly Generated number (QGN), to the client device, encrypted with the initial unique seed. The random number may include a start value (e.g., start byte) and a step value (e.g., number of bytes to jump from the previous byte), which may be used to obfuscate or encrypt and subsequently decrypt data that is processed with the first unique seed or encryption pad. In some aspects, the start value and/or the step value may be generated by the random number generator or qRNG or may be randomly selected by the service. Upon receipt of the first unique seed and random number, the client device may decrypt the first unique seed and random number or “key” using the initial unique seed. The client device may encrypt data for transmission to the service using the first unique seed according to the key (start value and step value). Upon receipt of the user data, the service may then communicate the data to another device using similar encryption techniques, but with different (or in some instances the same) seed or seeds. As can be appreciated from the above description, this encryption and communication process minimizes the opportunity for a breach in security of communication between the client device and the service, including interception and subsequent reading of the data or manipulation of the data.

Security may be further enhanced by the use of multiform factor authentication, which may include, but is not limited to, password authentication (all platforms), physical authentication (MAC address, IP Address, serial number, EMEI number, operating system (OS) version or version update logs, GPS coordinates, smart card, key fob, etc.), RFID (Radio Frequency Identification) or NFC (Near Field Communications) chips, and/or biometric authentication (iris/retina recognition, fingerprint/finger geometry recognition, face recognition, voice recognition, gait recognition, hand recognition, Odour recognition/Olfactory, signature recognition, typing recognition, vein recognition, etc.)

A client device, such as a mobile device or smart phone, laptop, tablet, or other computing device may register with the service to enable receipt and use of the seed generated by the service for obfuscation and secure communication of data. The client device may first download or otherwise access an installation file or other similar data structure or container containing an initial installation file or installation instance and an initial seed. The client device via or according to instructions contained in the installation file, may install a client application configured to communicate with the service/authentication server. The authentication server may then provision the beginning of a secure session between the client application and the server, whereby all registration information between the client and the server are secured, including communications prior to registration. This may be accomplished, for example, by communicating registration information using the initial seed provisioned in the installation file, which may be unique to the particular installation file. Furthermore, all data sent between two devices may be encrypted or obfuscated, such that no plain text or even data employing SSL encryption schemes is communicated between devices. In some cases, According to the described techniques, the probability of a successful Man in the Middle (MitM) attack may be significantly reduced and/or eliminated.

In some aspects, the service may continue generating subsequent unique seeds and communicate each subsequent seed to the client device by encrypting or obfuscating it with a previous seed. In this way, a secure communication link or tunnel between the client device and the service may be formed. In some cases, upon use of a certain part of the first seed, such as a number of bytes, the service may communicate part or all of a subsequent unique seed encrypted by the prior seed, for example, by appending the new seed to the end of messages or packets transmitted to the client device. In some aspects, two communication links or tunnels may be established between the client device and the service, to separate communication of data and subsequent seeds between the service and client device. In some aspects, this may provide or increase throughput or other communication performance metric(s) for communication of data between the service and the client device.

In the some instances, when the client application seeks or is instructed to decrypt or “unscramble” an encrypted message or data, the client application may first connect with the authentication server to start a secure session. Authentication with the server may include any of the multiform factor authentication as described above. As there may be only one instance of a communication, only the intended user may access the data. For example, if another user attempted to gain access to the tunnel via the recipient's credentials, they would gain access to another empty tunnel (or garbage-lain tunnel) that does not contain the desired data. In some instances, the transmission of data between clients can be, but is not limited to, data that is stored remotely to be viewed via the client application, transferred via Virtual Private Network (VPN), or sent via standard email to be descrambled on the receiving side. In some instances, the client application may act as a “dumb terminal”, interacting with information from the system without actually transferring it to local memory on the machine. This may be used, but is not limited to, using mobile computing technology as a Remote Access Terminal to perform tasks on a server that would tax the processing and would otherwise be possible to do on the host device for the client application.

In some aspects, registering or authenticating a client device with the service may include sending a one-time use URL to the client device or an auxiliary device via a different communication channel, such as over a wireless network via a short message service (SMS) message to a smart phone identified by the user associated with the client device, over public networks via an email to an identified email account, etc. Upon receiving the one-time use URL, the client device or auxiliary device may communicate an indication of a selection of the one-time use URL to the service. In some aspects the one-time use URL may link directly to the service or web-page associated with the service, providing an opportunity to enter further information to verify the user/client device or account.

In some aspects, the described techniques may be implemented by a browser enabled protocol running exclusively on HTTPS, making it highly improbable or even impossible to disable the protocol without also disabling all related HTTPS commercial communications. By implementing the described techniques in browser enabled protocol running exclusively on HTTPS, wide-scale integration across various platforms and operating systems may be achieved.

In some aspects, the described techniques may also be used automatically in place of cellular service to establish secure communications between remote devices. The described techniques may additionally or alternatively aid to prevent or reduce the loss of productivity due to interrupted cell phone service in a given location. The described techniques may also be implemented in various current networks without disruption or altering of current standard industry protocols or network infrastructure.

In embodiments, the described encryption techniques may be used in combination with drones or automated devices capable of capturing data (e.g., image data, audio data, etc.). In this example, the drone or automated device may be controlled to initiate and operate a secure communication link with a service, for example, using wireless communication technology. The data collected or captured by the drone may then be securely communicated using seeds provided by the service, to the service. In this way, sensitive information may be securely communicated to a service, and may minimize the memory capacity needed on the drone itself to capture a desired or larger amount of data. In embodiments, the client may operate on the same hardware components as the service. In this scenario, the service may act as a secure storage device, for example when the client and service are securely and sufficiently separated from one another.

In some embodiments, the encrypted data transmitted to the service by a client device may then be sent to one or more other or second devices, over similarly established communication links with the other device(s). In other aspects, the service may communicate the same seed or pad (e.g., third seed) and random number or QGN to both the client device and a second device. The service may encrypt the third pad with a first seed and send the encrypted third seed to the client device, and encrypt the third seed with a second seed and send the encrypted third seed to the second device. In this way, each device may receive the same seed to enable bypassing the service in communicating data directly between the two devices. In some instances, the service may update or refresh the common seed used between the devices by sending a new seed to one or both of the client devices. In a similar way as described above, two communication links may be established between the service and each device, for example, to bifurcate communication of data and subsequent seeds, to increase or otherwise ensure a data communication throughput between the devices and/or service.

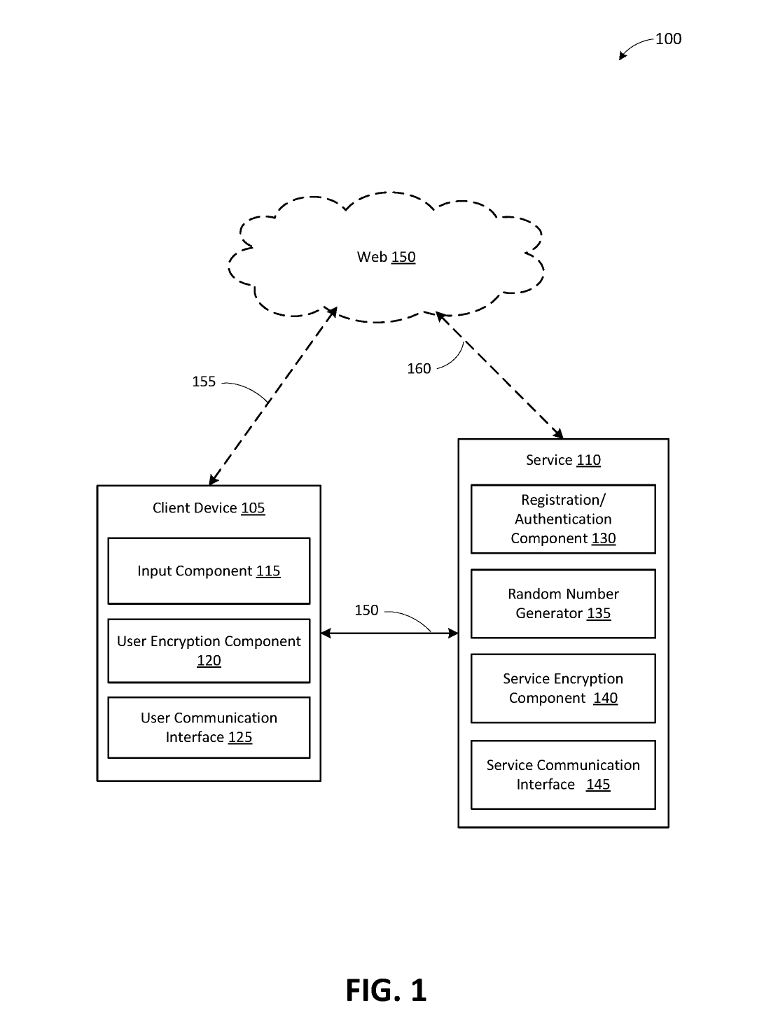

As set forth above, in accordance with the disclosed techniques, one or more secure communication links may be established between a device and the service, or between two devices, using unique seeds. FIG. 1 is a diagram illustrating an example of a system 100 including a client device 105 and a service 110 configured for establishing a secure communication link. In the example shown, the client device 105 and the service 110 may communicate with each other via communication link 150. The client device 105 may include, for example, a personal computer, a mobile device, a tablet, etc., and the service 110 may include or be implemented on any computing device including one or more servers, one or more virtual machines, etc. The client device 105 may include one or more input components 115, such as a keyboard, mouse, a touch pad, display, audio inputs/outputs, etc. The client device 105 may further include a user encryption component 120 and a user communication interface or transceiver 125. The service 110 may include a registration/authentication component 130, a random number generator (RNG) 135, a service encryption component 140, and a service communication interface or transceiver 145. The user and service communication interfaces 125, 145 may include one or more of a wireless transceiver, antenna, etc., supporting LTE, Wi-Fi or any other IEEE 802.11 standard, WiMAX or other 802.16 standards, or various other wireless communication standards, a wired communication interface supporting Ethernet and other communication protocols, etc. In some aspects, the client device 105 may communicate directly with the service 110 over communication link 150 or may route some or all communications through the web/public internet 150 via links 155 and 160. In some aspects, the system 110 may implement various levels of the database transactional properties of Atomicity, Consistency, Isolation, and Durability (A.C.I.D.), as are known in the art.

The RNG 135, which may be an example of a qRNG, may generate a number of initial unique encryption or obfuscation files for association with one or more installation files, that when downloaded by a client device 105, enable the client device 105 to establish a secure communication link with the service 110 and/or other devices. The service 110 may upload the installation files to the web 150 via link 160, and/or establish a link on the web 150 to the installation files when stored on or associated with the service 110. Subsequently, the input component 115 of the client device 105 may receive a command, selection, etc., instructing the device to install or download an installation file associated with the service 110, for example, to enable secure communication of data with the service 110 and/or another device. In one aspect, the client device 105 via the input component 115 may receive a selection of an installation file to download from the web 150 via link 155. The installation file may include an initial unique seed generated, for example, by the RNG 135 of the service 110, unique to that installation file or installation instance. In another aspect, the client device 105 may receive the installation file and the initial unique seed directly from the service 110 via link 150. The initial unique seed may be mathematically unbreakable or derivable, for example when RNG 135 includes a hardware random number generator 135, that operates based on quantum events, as generally known in the art.

The installation file may provide or populate an interface, for example via a client application, that enables association of one or more credentials with the client device 105, to register with the service 110. The one or more credentials may include a username, a password, a phone number, one or more email addresses, any number of answers to various user-selected or user generated questions, biometric credentials, and the like. Upon receiving one or more credentials, for example via the input component 115, the information may be organized into messages or packets and encrypted with the initial unique seed provided by the installation file, by the user encryption component 120. The encryption component 120 may combine each byte or other portion of the information or data to be transmitted/communicated to the service 110 with a byte or portion of the initial unique seed. In some cases, the combining may include performing a logic XOR between the byte of data and the byte of the seed. As will be appreciated by those skilled in the encryption arts, various other combination and/or encryption techniques may be used to a similar effect. Upon encryption of the registration information, the encrypted data/message or packet may be communicated to the user communication interface 125 and communicated to the service 110.

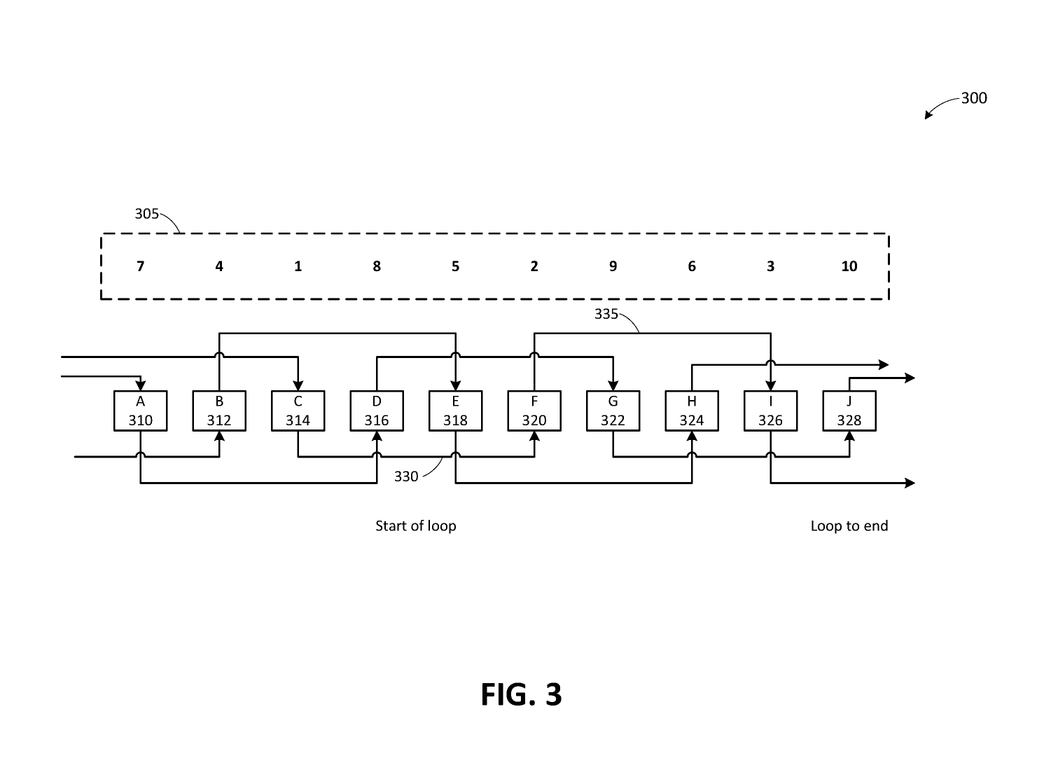

The service communication interface 145 may receive the encrypted registration information, and communicate the encrypted information to the service encryption component 140. The service encryption component 140 may decrypt the information using the initial unique seed associated with the installation file that was downloaded by the client device 105. The service encryption component 140 may detect which installation file has been accessed by the client device 105 via an indicator or other type of identifier in or associated with the initial unique seed to determine which initial seed to use to decrypt the registration information. The RNG 135 may, concurrently with, before, or after, the registration information is received/decrypted, generate a first unique seed. The seed itself will be described in greater detail in reference to FIG. 3 below. In some aspects, the seed may be a user unique seed that will be permanently or semi-permanently associated with the client device 105 and/or a user of client device 105 (e.g., such that is can be further associated with multiple devices designated by a common user). In some aspects, the RNG 135 will also generate a random number or QGN associated with the first seed, including a start value and a step value. The start value may define the starting byte, or other data unit, of the seed where encryption starts using the seed, and the step value may define how many bytes or other data unit to jump to determine the subsequent byte for encrypting the data/message. In some aspects, the start and step values may be randomly selected or generated by the RNG 135, and in other aspects may be randomly selected by another component or processor of the service 110. The random number or QGN and the seed may then be encrypted using the initial unique seed by the service encryption component 140 and transmitted/communicated to the service 105 by the service communication interface 145. Upon receipt of the encrypted first seed and random number or QGN via the user communication interface 125, the client device 105 may decrypt the message(s) via the user encryption component 120 and retrieve the first unique seed and the corresponding random number or QGN. The client device 105 may receive and/or designate data for secure transmission to the service 110 or to another device through the service 110, for example, via the input component 115 and/or the user communication interface 125. The data may be in various forms including various file types, may include text, images, audio information, video, and so on. The data may be communicated to the user encryption component 120 where it may be encrypted by the first unique seed according to the corresponding random number or QGN. The client device 105 may then transmit/communicate the encrypted data to the service 110 via the user communication interface 125. In some aspects, the service 110 may subsequently communicate the data received from the client device 105 to other devices using similar encryption techniques using different or in some cases the same seed(s).

In some aspects, the RNG 135 may continue to generate additional unique seeds for further data transfer between the client device 105 and the service 110. In some aspects, the subsequent unique seeds or portions thereof may be encrypted by the service encryption component 140 by the prior seed and communicated to the client device 105. In some cases, portions of new seeds may be encrypted by a prior seed and incrementally communicated to the client device 105 to establish a continuing secure communication tunnel between the service 110 and the client device 105. In some cases, a new random number or QGN including a newly generated or selected random start and/or step value may be associated with an existing seed. The new random number or QGN may be generated by either the client device 105 or the service 110 before and/or upon full use of the current seed to encrypt data. In this way, resources used for generating new seeds may be conserved, while still maintaining a high level of security for communications.

In some cases, the first unique seed generated by the service 110 may be designated a user unique seed. Upon receipt and decryption, the client device 105 may store, archive, and/or associate the user seed for future access and use of the service 110. In some aspects, the initial unique seed that is associated with the installation file may not be associated with a random number or QGN, such that the pad is used to encrypt data linearly. By associating and subsequently using the user seed, which may be associated with a random number or QGN, security may be further enhanced as the user seed may be more difficult to break and may only be communicated via encryption with the initial seed.

In other aspects, the initial seed may also be associated with a random number or QGN to further enhance security. In some cases, the random number or QGN may be provisioned with the installation file, may be retrievable via a secondary communication channel by the client device, or may be communicated to the client device 105 in other ways.

In some aspects, the initial seed may be stored by the client device 105 for later recovery, for example, if the user seed is corrupted or otherwise requires re-installation. In yet some aspects, the user seed including the associated random number or QGN may be stored by the client device 105 for recovery purposes.

The user pad may also be used by a user of the client device 105 to use the service 110 on other devices, for example laptops, personal computers, smart phones tablets, etc. Each different client device may be initialized using a different initial seed associated with separate installation files accessed by each device. Upon registration, the same user pad, however, may be associated with any number of devices, to enable more convenient and more intuitive access to secure data communication services offered by the service 110, without any noticeable reduction in security.

In some aspects, upon downloading the installation file, a client application including the user encryption component 120 may be installed on the client device 105 to enable data encryption via the service 110 as described above. In other cases, the interface provided to the client device 105 may be accessed via the web 150 over link 155. In some aspects, the client application may add additional security over a web-based interface, as it may not utilize SSL, HTTPS, or session cookies which pose potential security risks.

It should be appreciated that the encryption techniques provided by the service 110 may be used in conjunction with other encryption schemes, for example, as an added security measure. For example, the client device 105 may utilize a virtual private network (VPN) for secure communications. The client device 105 may encrypt data using seeds generated and provided by the service 110 as described above, and may further encrypt communications using VPN encryption techniques. In this scenario, the two encryption methods are performed separately (in any order) without causing any interference or disruption to each individual encryption system. In this way, the data encryption provided by the service 110 may be compatible with and non-disruptive to existing systems and security systems.

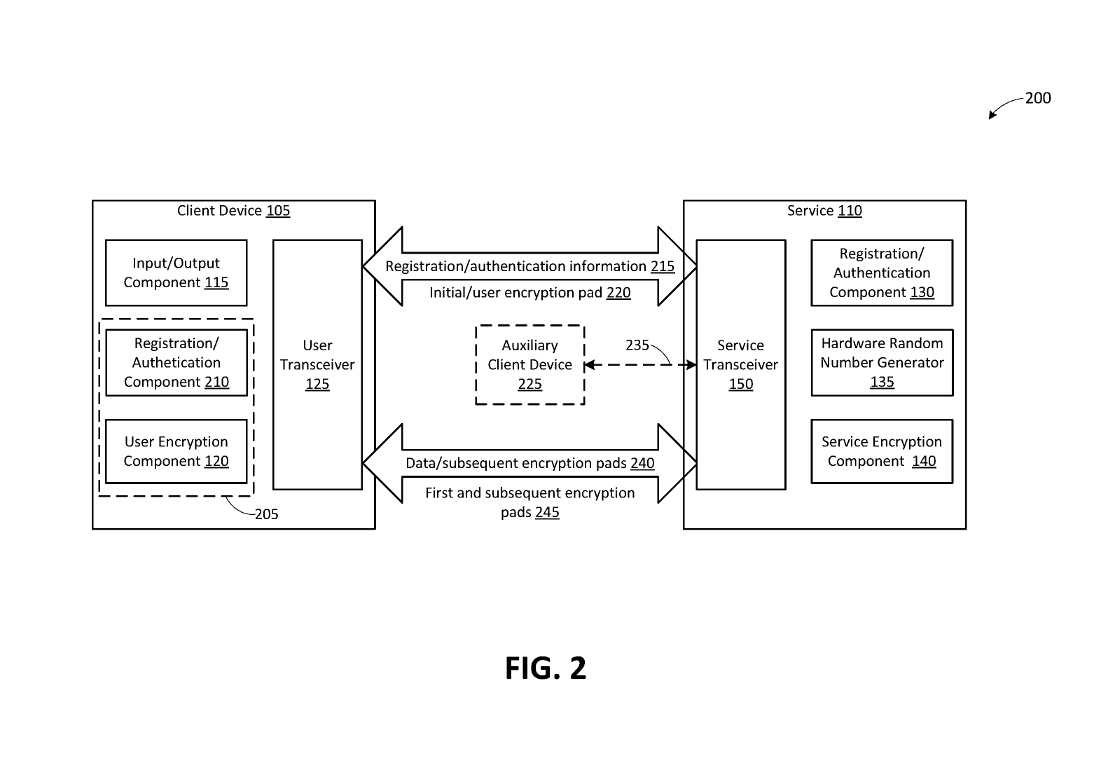

FIG. 2 illustrates another example system 200 illustrating a client device 105 and a server 110, in communication with each other via a secure communication link. The client device 105 and/or the service 110 may incorporate one or more aspects of client device 105 and service 100 described above. In the example illustrated, a client application 205 is operable on or associated with the client device 105, and may be installed on the client device 105 via an installation file associated with the service 110, for example, accessible over the web. The client application 205 includes a registration/authentication component 210, and a user encryption component 120, as also described above.

Upon downloading or otherwise accessing the installation file associated with the service 110, the client device 105 may communicate registration, or authentication information 215 after registration has been completed, using the user or initial unique seed 220 provided with the installation file. By using the initial encryption seedr/user seed 220 for registration and authentication, no unencrypted data is sent between the service 110 and the client device 105, thus increasing the security of communications between these devices/entities.

In the registration example, the registration/authentication component 210 may receive, via the input component 115, credential information 215 for registering with the service 110. The credential information 215 may include a user name, a password, a phone number, one or more email addresses, other additional contact information, personal information, device information, any number of answers to various user-selected or user generated questions, and/or one or more answers to service-defined questions. The registration component 210 may communicate and request or instruct the user encryption component 120 to encrypt the credential information 215 using seed 220 and transmit the encrypted information via the user communications interface 125 to the service 110. In some aspects, the process of registering may include receiving, by the input component 115, a user selection of one or more user-defined challenges and subsequent answers to the selected questions. This information may also be communicated to the service 110 using the initial unique seed 220 by the user communications interface 125.

In some cases, multifactor authentication may also be implemented in the registration or authentication process. For example, after receiving the credential information 215, the service 110 may communicate a one-time use URL via a secondary communication link identified in the credential information 215. In one example, this may include sending an SMS message or an email, for example, to an auxiliary client device 225 over communications link 235. The one-time use URL may be encrypted with the user or initial seed 220, or may be unencrypted. In some aspects the one-time use URL may be sent over the same communication link as the registration/authentication information. The auxiliary client device 225 may receive a selection or input indicating a selection of the one-time user URL. The selection/indication may be communicated back to the service 110 over link 235, thus providing greater assurance that the client device 105/user of client device 105 is in fact associated with a valid and legitimate use of the service 110. Furthermore, a cloned device will not have access to all of the information exchanged encrypted with the service 110, making a break in security even more difficult with this secondary form/multifactor form of registration/authentication.

Subsequently, a first seed (which in some cases may be a user seed, as described above) and corresponding random number or QGN may be generated by the hardware RNG 135, encrypted by the service encryption component 140 with the initial seed 220, and communicated to the client device 105 by the service communication interface 150. The client device 105 may then encrypt data 240 using the first and subsequent seeds 245 and communicate the encrypted data securely to the service 110, as described above. The client device 105 may also receive subsequent seeds 240 also encrypted by the first and subsequent seeds 245, to ensure continuous and uninterrupted secure communications with the service 110.

In accessing the service 110 after initial registration, the client device 105, via the input component 115, may receive authentication information to authenticate the client device 105 with the service 110 in order to receive unique seeds from the service 110. The client device 105, via the input component 115, may receive a user name and password associated with an account with the service 110/the client device 105. The user name and password (e.g., part of authentication information 215) may then be encrypted with the initial seed 220 associated with the client device 105 or a user seed, as described above, and communicated to the service 110. If the username and password information match the authentication information stored on or accessible by the service 110 (e.g., the same username and password matching an IP address of a client device 105 already in the system), then the service 110 may send one or more user-defined challenges/questions back to the client device 105 using the same seed 220. The one or more user-defined challenges may be used to identify the user/client device 105 to the service 105 based on preloaded knowledge unique to the client device 105 in a challenge/counter challenge response (e.g., akin to the military challenge process). In some aspects, a number M challenges may be associated with the user/client device 105. In any given authentication process, a number N, which may be a subset of M, challenges may be presented to the client device 105. The N challenges may be randomly selected or selected according to a preset order, based on previous login attempts, etc. The client device 105 may receive via the input component 115 answers to the user-defined challenge(s), encrypt the answer(s) with the pad 220, and transmit the encrypted answer(s) back to the service 110. All validation may take place on or be associated with the service 110, such that no responses to the challenges are communicated to the client device 105 from the service 110.

In some aspects, the authentication process may further include the service 110 generating, encrypting, and/or transmitting one or more service-defined challenges to the client device 105. The one or more service-defined challenges may include a “word of the day” type of a challenge, and may be used to identify/verify the service 110 to the client device 105. In some aspects, the client device 105 may not have any input on what the service-defined challenge(s) will be. In some aspects, authentication information may be chosen or selected by the service 110 and communicated (after being encrypted) to the client device 105 periodically (e.g., at authentication, various periods of continued communications, etc.), or at random intervals, over the secure communications link using the first or subsequent seeds 245 or over other communication links 235, for example to an auxiliary client device 225. In this way, an additional verification of security between the client device 105 and the service 110 may be implemented.

FIG. 3 depicts a portion of a unique seed 300 and a process for encrypting data, represented by numbered bytes 305, with the unique seed 300. The unique seed 300 may be an example of the initial, user, first, and/or subsequent unique seed described above in reference to FIGS. 1 and/or 2. A user via a client device 105 may select data, including any type of file or other data container, to upload, including Binary files or previously encrypted files. In some aspects the client application 205 and/or the user encryption component 120 may select boundary conditions for the random number or QGN to be used in encrypting the data, including a start value and a step value. In other aspects, the service 110 may select the start and the step values, for example using the RNG 135. The start point may be any point (e.g., any bit or byte) in the seed, such as an integer between 0 and the total pad size minus 1. The step value may be any integer greater than 1 and less than the pad size minus 1. In some cases, the start and/or step values may be selected randomly. In some aspects, the pad size may be selected, predetermined, such as based on data type, amount of data etc., or the pad size may vary per pad based on random number selection, etc. In some aspects, the pad may be or be associated with a prime number of bytes, so that for encryption, every start and step value combination results in the entire pad being utilized without getting caught in a repetitive loop.

In some aspects, an seed may include 100,003 bytes (the smallest prime number above 100,000), for example generated by a RNG 135 (which may in some cases be a hardware RNG). The seed 300 combined with the start and step values (e.g., the random number or QGN), may provide 10,000,500,006 initial conditions or possible options for a decryption sequence. The client application 205/user encryption component 120, may process the file or other data container being encrypted byte by byte, linearly, encrypting or combining each byte of data with a corresponding byte from the seed 300, according to the associated start and step value. For every byte stepped forward in the file or data container, the step count function may advance N places forward in the pad and use and combine that value with the byte of data in the file.

In the example illustrated in FIG. 3, the numbers 305 may represent bytes of data in the file or other data container to be encrypted. The data may include registration information or authentication information in some cases, and/or may include data to be communicated to the service 110 or another device. Blocks A 310 through J 328, positioned directly below the file byte numbers 305, may represent bytes of a seed 300. In this simplified example, the seed may be associated with a start value of 3 and a step value of 3. Data encryption may begin by encrypting or combining (XOR'ing) file byte 1 with encryption byte C 314. The process for encrypting the data may continue by jumping 3 encryption bytes at 330 to combine file byte 2 (e.g., according to a linear progression) with encryption byte F 320. Next, file byte 3 may be combined with encryption byte I 326 by jumping at 335 by 3 bytes. The process may continue encrypting each subsequent byte of the file with every third encryption byte until either the entire file is encrypted or until the entire seed is used, at which point, the encryption process may start over using encryption byte C 314. The step function may be represented by:

Next byte in pad=(current byte+step value)mod(pad_size) (1)

Equation 1 may cause the seed to wrap so that each byte in the pad can be utilized, if needed, for encryption by looping through the pad. By utilizing equation (1), each different start and step value may provide a different sequence of bytes of the seed utilized in the loop. As stated above, with a seed having 100,003 bytes, a total of over 10 billion encryption patterns or sequences are possible. In the case a file or other data container is bigger or contains more bytes than the number of bytes in the seed, the encryption loop may be started over to continue encrypting the data in a similar fashion. In some aspects, each bit of information may be individually encrypted by a different seed, for example, using common or different start and step values. In the example described above, this implementation would include encrypting each byte in the same order, with the addition of encrypting each bit of each byte with a different seed, such that 8 seeds are used in parallel to encrypt each byte of data. This implementation may further increase the possible sequences of encrypted data for the purposes of decryption significantly, thus making the encryption or de-facto encryption scheme that much harder to crack.

In one example, instructions for execution on a processor to implement encryption of data according to the described techniques may be provided by the following:

```
private void Button1_Click(object sender, EventArgs e) encrypt
        {
            int num = Strings.Len(Strings.Trim(this.tbPassword.Text)); //user password, credentials,
and/or environmental variables
            checked
            {
                byte[ ] array;
                if (num == 0)
                {
                    array = new byte[ ]
                    {
                        0
                    };
                    num = 1;
                }
                else
                {
                    array = new byte[num − 1 + 1];
                    int arg_42_0 = 0;
                    int num2 = num − 1;
                    for (int i = arg_42_0; i <= num2; i++)
                    {
                        array[i] =
(byte)Strings.Asc(Strings.Mid(Strings.Trim(this.tbPassword.Text), i + 1, 1));
                    }
                    array[0] = 0;
                }
                string desktop = MyProject.Computer.FileSystem.SpecialDirectories.Desktop;
                byte[ ] array2 = Qgn_Seed;
                int num3 = array2.GetUpperBound(0) − 1;
                string fileName = File_being_sent;
                if (MyProject.Computer.FileSystem.FileExists(fileName))
                {
                    byte[ ] array3 = fileName_TO_BYTE_ARRAY; // The file that is being
sent
                    byte[ ] array4 = new byte[array3.GetUpperBound(0) + 1];
                    int arg_116_0 = 0;
                    int upperBound = array3.GetUpperBound(0);
                    for (int i = arg_116_0; i <= upperBound; i++)
                    {
                        int num4 = i % num3;
                        int num5 = i % num;
                        array4[num4] = (array3[num4] \hat{ } array2[num4] \hat{ }
array[num5]);
                    }
                    MyProject.Computer.FileSystem.WriteAllBytes(fileName + “.enc”,
array4, false);
                }
            }
        }
        private void Button2_Click(object sender, EventArgs e) //decrypt
        {
            int num = Strings.Len(Strings.Trim(this.tbPassword.Text));
            checked
            {
                byte[ ] array;
                if (num == 0)
                {
                    array = new byte[ ]
                    {
                        0
                    };
                    num = 1;
                }
                else
                {
                    array = new byte[num − 1 + 1];
                    int arg_42_0 = 0;
                    int num2 = num − 1;
                    for (int i = arg_42_0; i <= num2; i++)
                    {
                        array[i] =
(byte)Strings.Asc(Strings.Mid(Strings.Trim(this.tbPassword.Text), i + 1, 1));
                    }
                    array[0] = 0;
                }
                string desktop = MyProject.Computer.FileSystem.SpecialDirectories.Desktop;
                byte[ ] array2 = MyProject.Computer.FileSystem.ReadAllBytes(desktop +
“\\Garbage”);
                int num3 = array2.GetUpperBound(0) − 1;
                this.OpenFileDialog2.InitialDirectory = desktop;
                this.OpenFileDialog2.Filter = “Coded Files (*.enc)|*.enc”;
                this.OpenFileDialog2.FilterIndex = 1;
                this.OpenFileDialog2.ShowDialog( );
                string fileName = this.OpenFileDialog2.FileName;
                if (MyProject.Computer.FileSystem.FileExists(fileName))
                {
                    byte[ ] array3 =
MyProject.Computer.FileSystem.ReadAllBytes(fileName);
                    byte[ ] array4 = new byte[array3.GetUpperBound(0) + 1];
                    int arg_132_0 = 0;
                    int upperBound = array3.GetUpperBound(0);
                    for (int i = arg_132_0; i <= upperBound; i++)
                    {
                        int num4 = i % num3;
                        int num5 = i % num;
                        array4[num4] = (array3[num4] \hat{ } array2[num4] \hat{ }
array[num5]);
                    }
                    MyProject.Computer.FileSystem.WriteAllBytes(Strings.Mid(fileName,
1, Strings.Len(fileName) − 4), array4, false);
                }
            }
        }
```

In some aspects, once data is encrypted using a seed, the used portion of the seed may be discarded. Encryption may continue using another seed, for example, supplied incrementally to the client device 105 as the prior seed is used or depleted. In this way, the possibility of an unwanted third party discovering or breaking the encryption decreases significantly.

In some aspects, an seed, the initial/user seed or the currently used seed, may be stored, on the client device 105. In some aspects, the seed may be stored in binary, in hex, or in any other suitable format. In other aspects, seeds may be immediately discarded as they are used, so as to prevent any unwanted access to the seeds, which may result in the encryption being broken. In some aspects, each time a client device 105 accesses the service, a new installation file may be provided with a unique initial seed. In this way, outside access to the seeds used for communication may be practically eliminated.

It should be appreciated that diagram 300 is given only by way of example. Generally the seeds utilized and described in this disclosure will be much greater in length. Additionally, or alternatively, other variations of encryption may be used with a unique seed. For example, the file data may be processed in a non-linear way (e.g., randomly or according to a preselected function, selecting bytes of data to be encrypted with the next encryption byte) to provide for increased security or according to other encryption techniques, or to be more easily combined with other encryption technique, and so. In some aspects, the step size and/or start values may be defined by equations, for example, associated with one or more variables, making these values dynamic and even more difficult to ascertain by unwanted parties.

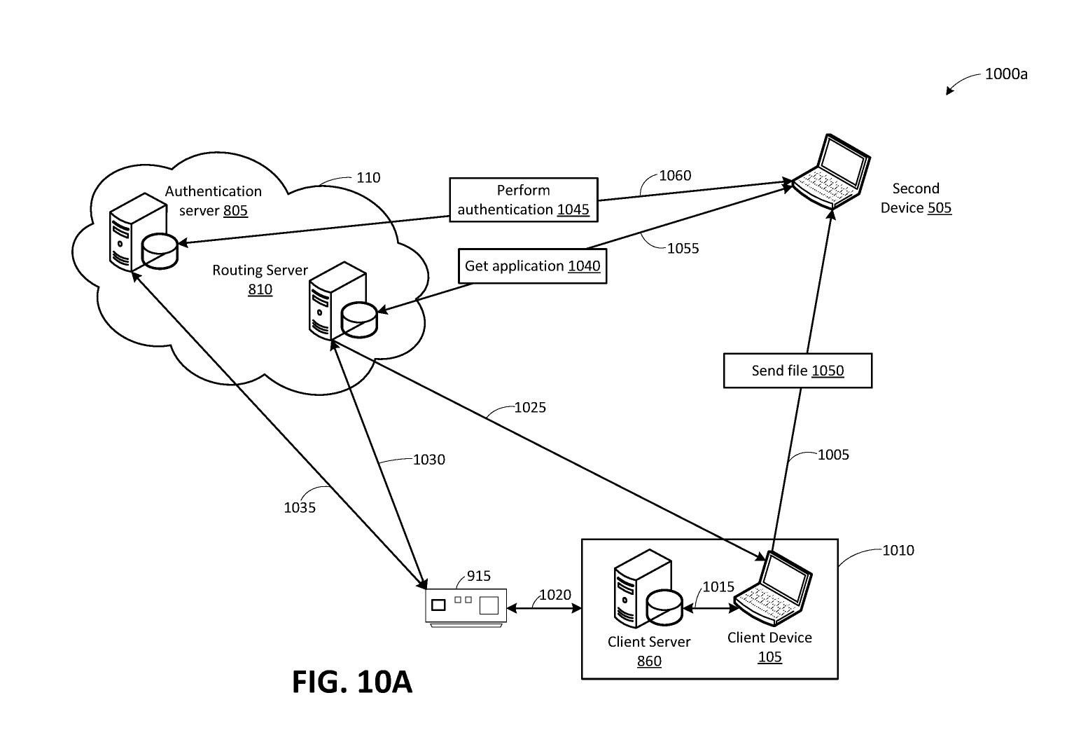

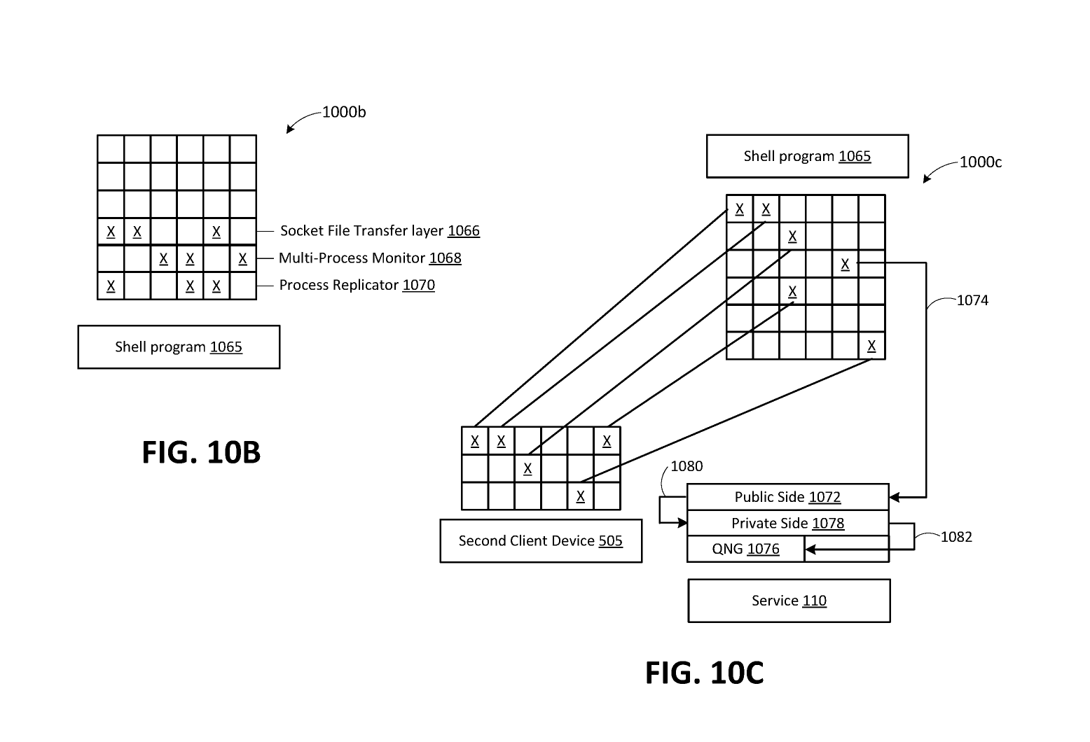

In some aspects, the unique seed and the random number or QGN, including a start and step value, may be generated based on a three tier process, as will be described below in reference to FIGS. 10A, 10B, and 10C An initial random number or seed may be generated by quantum computing techniques. A second number may then be randomly derived from the initial seed in a random sequence. The second number may indicate a start value relative to the initial random seed. A third number may be randomly derived from the first or second number in a similar way, and may indicate a step value relative to the start value and associated with the initial random seed. In this way, the generation of a seed and random number/QGN may be further randomized and complexity added thereto, to further enhance the security of data encrypted using the seed and QGN.

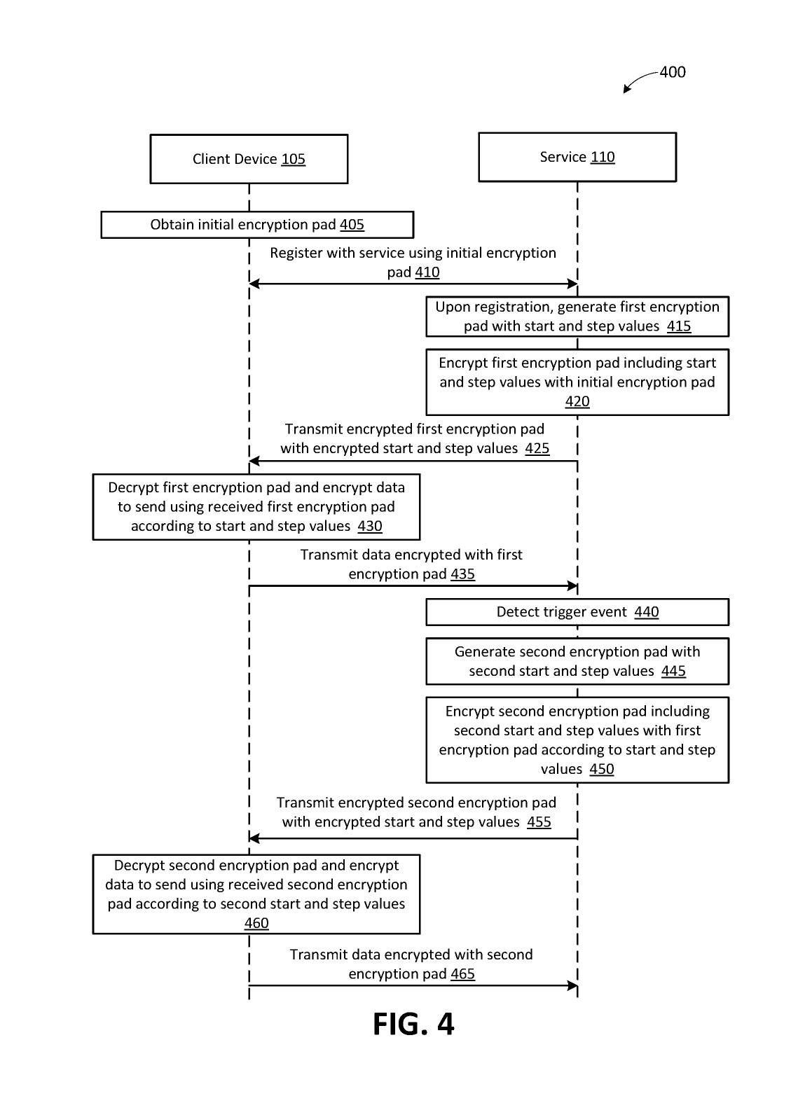

FIG. 4 depicts a flow diagram 400 of an example process for establishing a secure communication link 110 and transferring data between a client device 105 and service 110 in accordance with the present disclosure. Process 400 may be implemented by systems 100 and/or 200, for example, utilizing the seed 300 and associated processes for encryption described above in reference to FIGS. 1, 2, and/or 3. The operations of process 400 may be performed by the client application 205, the input component 115, and/or the user communication interface 125 of client device 105, and/or the registration/authentication component 130, RNG 135, service encryption component 140, and/or the service communication interface 145 of the service 110. In some aspects, some operations depicted in FIG. 4 may be optional.

The client device 105 may obtain an initial seed at operation 405, for example by downloading an installation file associated with a data encryption service 110. The client device 105 may register with the service 110 by encrypting registration information with the initial seed at operation 410. In some aspects, registration 410 may include the service 110 confirming or sending other information to the client device 105, also encrypted with the initial seed. Upon registration, the service, for example via RNG 135, may generate a first seed and associate a random number or QGN with the first seed including a start and step value at operation 415. To ensure secure communication of the first seed to the client device 105, the service 110 may encrypt the first seed and random number or QGN with the initial seed at operation 420, and transmit the encrypted first seed to the client device at operation 425.

If registration information or other encrypted data is intercepted in route to the client device 105, the interceptor or the Man in the Middle (MitM) may still potentially use the information to register. However, the MitM will only be able to register as another user and will not be able to impersonate the actual user device 105/user because each installation file and hence each initial seed is unique to that particular installation instance (e.g., the hash identifier will be different from the requesting user). In other words, the information used at registration is hashed and used to modify the initial seed. Thus, there is no way the MitM can register as the user; rather two distinct accounts would be created.

The client device 105 may decrypt the first seed (and start and step values) using the initial seed and encrypt data to transmit to the service 110 using the first seed according to the start and step values in the associated random number or QGN, at operation 430. The client device 105 may then transmit the encrypted data to the service at operation 435. In some aspects, the service 110 may detect a trigger event at operation 440. The trigger event may include an amount of data received from the client device 105, for example, relative to the size of the first seed. The service 110 may define or access a threshold size, such as a number of bytes, of an seed already used for encryption. The threshold number of bytes may indicate to the service 110 that it is time to generate and transmit a second seed or a portion thereof to the client device 105, for example, to ensure that the client device 105 can continue encrypting and transmitting data to the service 110 without interruption. In some aspects, the threshold size may be determined based on an indication of the size or type of data being communicated from the client device 105. In some aspects, the threshold size may be a default value, for example a percentage or fixed number of bytes of an seed that have already been used for encryption or that are still available for encryption. Upon detection of the trigger event, the service 110 may then generate a second seed with start and step values at operation 445. The service 110 may encrypt the second seed and random number or QGN using the first seed at operation 450 and transmit the encrypted second pad and random number or QGN to the client device at operation 455.

In yet other aspects, upon a detecting a trigger event at 445, which may include an indication that the entire first seed has been used for encrypting, the service 110 may generate a second random number or QGN for use with the first seed (not shown). The service 110 may then transmit the second random number or QGN to the client device 105 after encrypting the second random number or QGN with the first seed.

In either event, the client device 105 may receive and decrypt the second seed (or second random number or QGN) using the first seed and subsequently encrypt more data to be transmitted using the second seed according to the start and step values (or using the first seed according to the second random number or QGN) at operation 460. The client device 105 may transmit the encrypted data at operation 465 to the service 110. Process 400 may continue, for example, looping through steps 445 through 465 until the client device 105 is finished transmitting data to the service 110, at which point process 400 will end, and the client application 205 on the client device 105 may be closed.

At any, and possibly multiple points in process 400, the service may verify the security of the communications with the client device 105 (or vice versa) by hashing and performing check sum operations on the received data and/or seeds, to ensure that there has been no breach in security, according to techniques well known in the art. In some aspects, the check sum process may include determining/comparing a number of parity bits to indicate transmission or other error in the communicated data. In some aspects, parity bits may be layered, for example, including an environmental layer and a syntactical layer. In some aspects the syntactical layer may include additional bits, which further may indicate on a more detailed level, if any bits of the transmitted data have any errors and/or have been modified/intercepted. At any point of a detected breach in security, the communication session may be terminated.

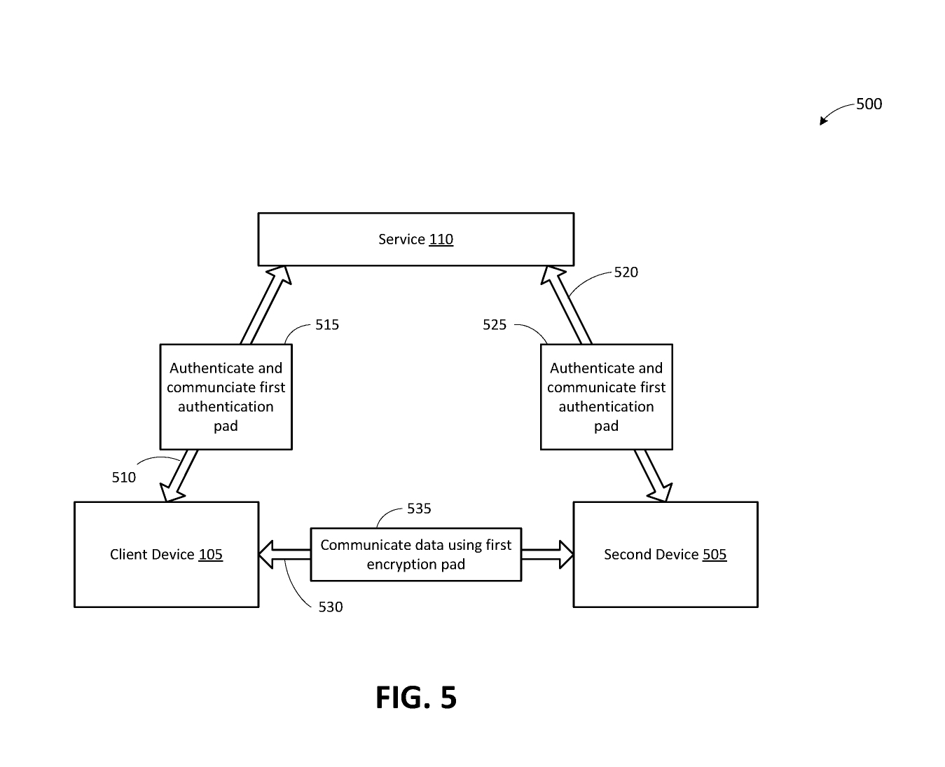

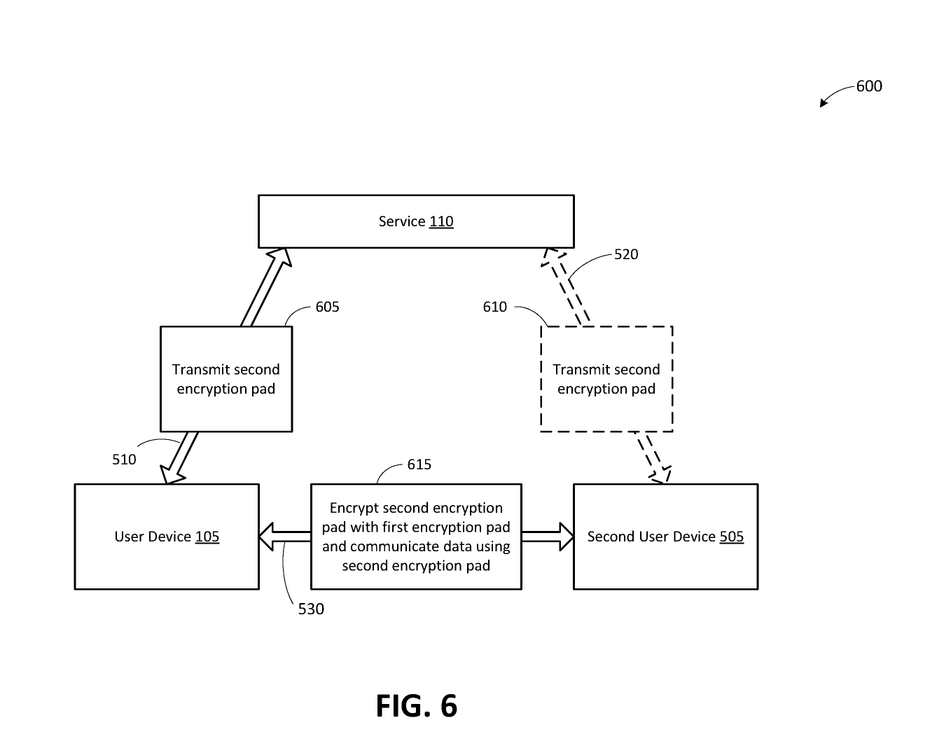

With reference to FIGS. 5 and 6, system 500 and 600 for establishing a secure communication link between two devices 105 and 505 using an intermediary service 110 are illustrated. Systems 500 and 600, client device 105, and/or service 110 may incorporate one or more aspects of systems 100 or 200, may utilize seed 300 and associated process, and or may implement part or all of process 400 as described above in reference to previous FIGs.

In system 500, a user of client device 105 may request to transmit data securely to a second device 505. In this instance, the client device 105 may first establish a secure communication link 510 with the service 110, for example, by performing authentication and receiving a first seed with a random number or QGN at operation 515. The client device 105 may indicate to the service 110 an intended recipient of data, for example a second device 505. The service 110 may communicate the indication to the second device 505. In other aspects, the client device 505 may communicate a request to establish a secure communication link using service 110 to the second device 505 directly, for example, via any communication technology supported by the client device 105 and the second device 505. In either event, upon receiving an indication/request to communicate with the client device 105, the second device 505 may establish a secure communication link 520 with the service 110 via first completing an authentication/registration process, and then by receiving the first seed with the random number or QGN, at operation 525, from the service 110.

As both the client device 105 and the second device 505 have received the same first seed and the same random number or QGN, they may subsequently communicate data encrypted by the first seed using the random number or QGN directly at operation 535 over link 530. In some aspects, the first seed generated by the service may be of a length to accommodate a larger amount of data for communication between the client device 105 and the second device 505. For example, the first seed may include more bytes to reduce and/or eliminate the need to transmit subsequent seeds to one or both devices 105, 505. In some cases, one of the client device 105 and second device 505 may generate a second random number or QGN for use with the first seed. In this way, more data may be securely communicated between devices 105, 505 without requiring one or more additional seeds.

In other aspects not illustrated, the client device 105 may transmit encrypted data first to the service 110 for communication to the second device 505. The second device 505 may establish a secure communication link 520 with the service 110 using a different seed/random number or QGN than utilized over link 510 between the client device 105 and the service 110. The service 110, upon reeving encrypted data from the client device 105, may decrypt the data, and re-encrypt the data using a different seed/random number or QGN already communicated to the second device 505 over link 520. In this way, the service 110 may act as a relay between the client device 105 and the second device 505 for communication of data over two secure communication links 510, 520. This implementation may provide additional security, for example, due to the fact that in order to break the encryption, less time will be available to attempt to decrypt either of the seeds used.

System 600 of FIG. 6 illustrates an example system for continued secure communication of data after a first seed is used and discarded, relative to the example depicted in FIG. 5. Upon expiration of a first seed or occurrence of a trigger event, the service 110 may generate a second seed and random number or QGN. The service 110 may transmit the second pad and random number or QGN to the client device 105 at operation 610 over secure communication link 510. In one aspect, the client device 105 may encrypt the second seed and random number or QGN with the first seed and communicate the encrypted second pad to the second device 505 at operation 615 over link 530. The second device 505 may then implement and use the second seed for further communications with the client device 105 over secure communication link 530. New pads may be generated and relayed through the client device 105 to the second device 505 in a similar manner according to the amount of data being communicating between devices 105 and 505.

In some cases, new seeds may be relayed through the second device at operation 610 over link 510 to then be communicated to the client device 505. In some cases, the service 110 may alternate between client device 105 and second device 505 to which to transmit a subsequent seed or may send subsequent pads to both devices 105, 505.

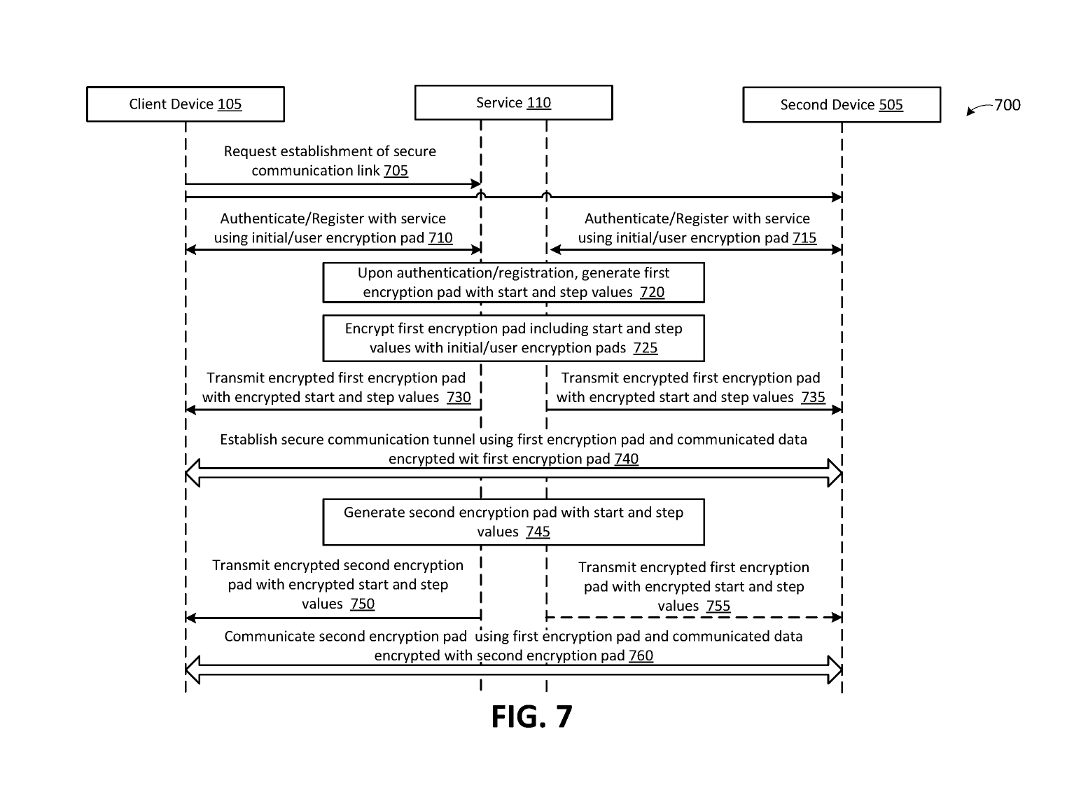

FIG. 7 depicts a flow diagram 700 of an example process for establishing a secure communication link for data transfer between two devices 105, 505 utilizing an intermediary service 110. Process 700 may be implemented by systems 500 and/or 600, for example, utilizing seed 300 and associated processes for encryption, and/or may include portions of process 400 described above in reference to FIGS. 3, 4, 5, and/or 6. The operations of process 700 may be performed by the client application 205, the input component 115, and/or the user communications interface 125 of client device 105/second device 505, and/or the registration/authentication component 130, RNG 135, service encryption component 140, and/or the service communications interface 145 of the service 110. In some aspects, some operations depicted in FIG. 7 may be optional.

The client device 105 may first transmit a request to establish a secure communication link with the second device 505, either by routing the request to the service 110, to the second device 505 directly, or a combination thereof, at operation 705. The client device 105 in tandem with the second device 505 may each obtain an initial seed, for example by downloading an installation file associated with a data encryption service 110. The client device 105 and the second device 505 may register/perform authentication with the service 110 by encrypting registration or authentication information with their respective initial/user specific seeds at operations 710 and 715. Operations 710 and 715 may include aspects of operation 410 described above. Upon registration, the service 110, for example via a RNG, may generate a first seed and associate a random number or QGN with the first seed including a start and step value at operation 720. To ensure secure communication of the first seed to the client device 105 and the second device 505, the service 110 may encrypt the first seed and random number or QGN with the initial/user seed associated with the client device 105 and may separately encrypt the first seed and random number or QGN with the initial/user seed associated with the second device 505, at operation 725. The service 110 may then transmit the encrypted first seeds to the client device 105 and the second device 505 at operations 730 and 735.

Using the first seed and random number or QGN, the client device 105 and the second device 505 may establish a secure and direct communication tunnel between devices 105 and 505 at operation 740 and communicate data back and forth as desired and as described above. Upon the occurrence of a trigger event (e.g., a certain portion of the seed being used for encryption, for example indicated to the service 110 via a request for another seed), the service 110 may generate a second seed and random number or QGN including start and step values, at operation 745. In some aspects, the service 110 may then either encrypt the second seed and random number or QGN with one or more of the initial/user seeds of the respective devices 105, 505, or with the first seed. The service 110 may transmit the encrypted second pad and random number or QGN to the client device 105 and/or the second device 505 at operations 750 and 755. The devices 105 and 505 may continue to communicate encrypted data using the second and potentially subsequent seeds, at operation 760.

At any, and possibly multiple points in process 700, the service 110 may verify the security of the communications with the client device 105 and/or the second device 505 (or vice versa) by hashing and performing check sum operations on the received data and/or seeds, to ensure that there has been no breach in security, via techniques well know in the art. At any point of a detected breach in security, the communication session/communication link(s) may be terminated.

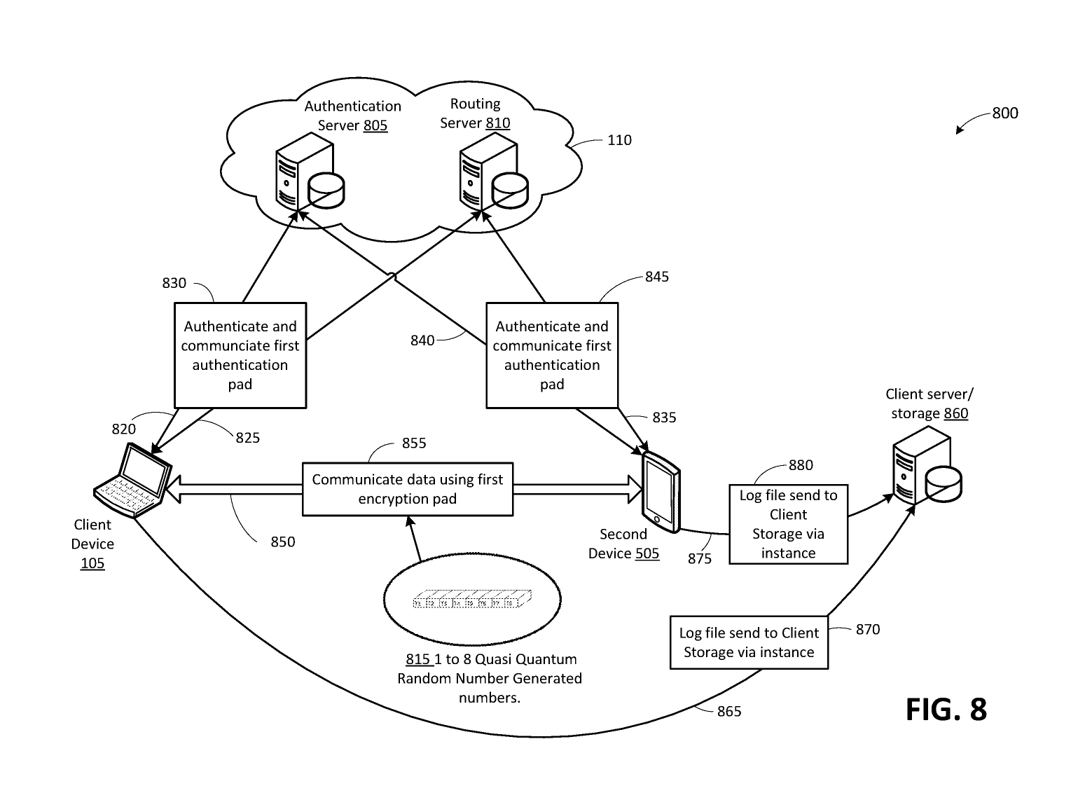

With reference to FIG. 8, system 800 for establishing a secure communication link between two devices 105 and 505 using an intermediary service 110 is shown. System 800, client device 105, and/or service 110 may incorporate one or more aspects of systems 100 or 200, may utilize seed 300 and associated process, may implement part or all of process 400, and/or may be represent a specific example of system 500, as described above in reference to previous FIGs.

In system 800, a user of client device 105 may request to transmit data securely to a second device 505. In this instance, the client device 105 may first establish a secure communication link 820 with the service 110, for example, by performing authentication via interacting with authentication server 805 associated with service 110 and receiving a first seed with a random number or QGN at operation 830. The client device 105 may indicate to the service 110 an intended recipient of data, for example a second device 505, via communications with routing server 810 via communication link or tunnel 825. In some aspects, data communicated across this tunnel 825 may also be encrypted using the encryption seed received from the authentication server 805. The service 110 may communicate the indication to the second device 505. In some cases, this may include transmitting a request to connect, including a one-time initial encryption seed, to device 505 by the routing server 810 via link 835. In other aspects, the client device 505 may communicate a request to establish a secure communication link using service 110 to the second device 505 directly, for example, via any communication technology supported by the client device 105 and the second device 505. In either event, upon receiving an indication/request to communicate with the client device 105, the second device 505 may establish a secure communication link 840 with the service 110 via first completing an authentication/registration process with authentication server 805, and then by receiving the first seed with the random number or QGN, at operation 845, from the service 110.

As both the client device 105 and the second device 505 have received the same first seed and the same random number or QGN, they may subsequently communicate data encrypted by the first seed using the random number or QGN directly at operation 855 over link 850. In some aspects, the first seed generated by the service may be of a length to accommodate a larger amount of data for communication between the client device 105 and the second device 505. For example, the first seed may include more bytes to reduce and/or eliminate the need to transmit subsequent seeds to one or both devices 105, 505. In some cases, one of the client device 105 and second device 505 may generate a second random number or QGN for use with the first seed. In this way, more data may be securely communicated between devices 105, 505 without requiring one or more additional seeds.

The data communicated at operation 855 may be encrypted or obfuscated using the techniques described above in reference to FIG. 3. In some cases, the obfuscation may include encrypting each bit of information in each byte in parallel at operation 815 to further increase the difficulty by which the seed may be determined by an unwanted recipient. In some aspects, the initial seed used by the client device 105 and/or second device 505 may also utilize 8 parallel seeds for encrypting each byte of information communicated.

In other aspects not illustrated, the client device 105 may transmit encrypted data first to the service 110 for communication to the second device 505. The second device 505 may establish a secure communication link 840 with the service 110 using a different seed/random number or QGN than utilized over link 820 between the client device 105 and the service 110. The service 110, upon receiving encrypted data from the client device 105, may decrypt the data, and re-encrypt the data using a different seed/random number or QGN already communicated to the second device 505 over link 840. In this way, the service 110 may act as a relay between the client device 105 and the second device 505 for communication of data over two secure communication links 820, 840. This implementation may provide additional security, for example, due to the fact that in order to break the encryption, less time will be available to attempt to decrypt either of the seeds used.

In addition to communications between devices 105 and 505, the described techniques may also be used to securely store data, for example on network, such as a local network, associated with either of the client device 105 or second device 505. In one aspect, data for storage, such as logs of prior communications, states of various processes of device 105, 505, etc., represented by blocks 870 and 880 respectively, may be encrypted using seeds provided by service 110 and stored in or associated with a client server/storage 860 via communication links 865 and 875. By storing data locally, on networks associated with a client device 105, for example, data security may be enhanced by prohibiting outside access via already-implemented security procedures of the local network. In some cases, the seed(s) and QGN(s) including start and step value may be stored in another location, further increasing the level of sophistication and processing abilities necessary to compromise the security of the stored data. In some aspects, data at rest or stored data may be associated with a corresponding signature including the subscriber identification number and all derived seeds from that subscriber's one time pad or seed.

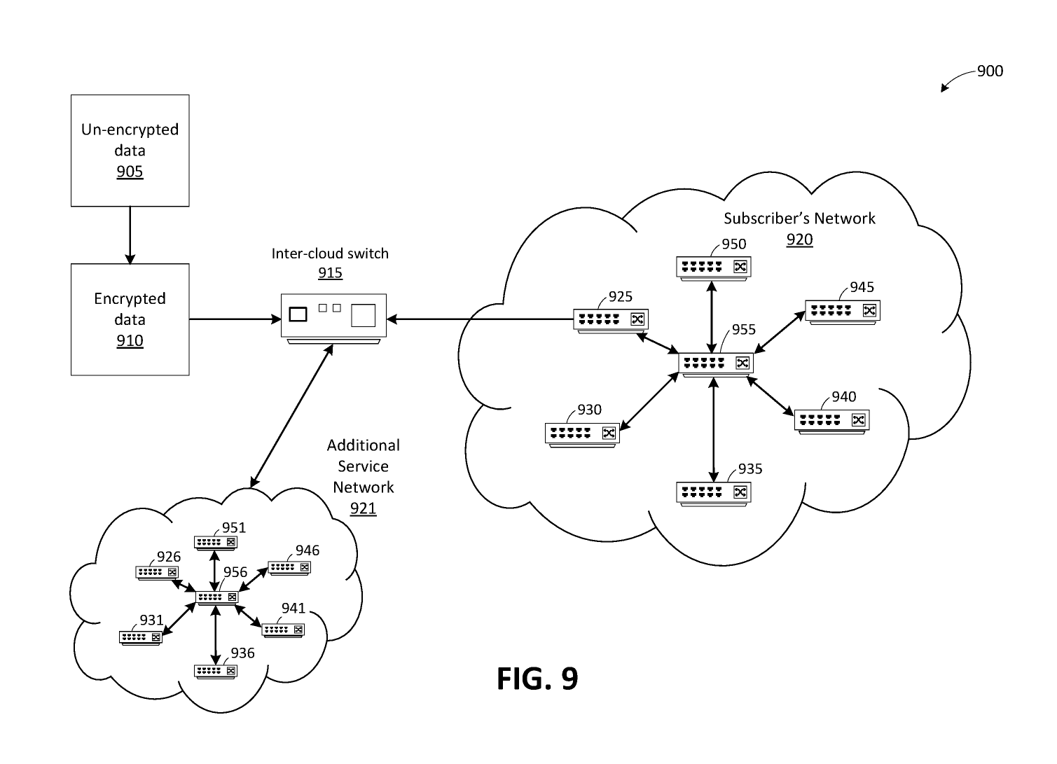

FIG. 9 illustrates an example data obfuscation or encryption system 900, which may utilize one or more of the techniques described above. The data encryption service, such as service 110 described above, may be implemented via an inter-cloud switch or component 915, which may be co-located with one or more client devices 105. In some aspects, the inter-cloud switch 915 may perform one or more aspects of the routing server 810 described in reference to FIG. 8, localized to one or more specific client devices 105. System 900 may include one or more subscriber's networks 920, 921, with each network 920, 921 associated with a number of computing or client devices 925, 930, 935, 940, 945, 950, 955 and 926, 931, 936, 941, 946, 951, 956, respectively. Each networks 920, 921 may be organized in a hub and spoke configuration, with one computing device/server instance of service 110, 955, 956 acting as the hub. Each networks 920, 921 may operate in conjunction with legacy and other existing systems, including the internet of things, and be separate from those systems.

In the example illustrated, unencrypted data may be received or selected at 905, for transmission or storage, for example, at a client device 105. According to the techniques described above, and in communication with service 110, the data may be encrypted using any number of seeds per byte of information (e.g., 1 to 8 seeds) at 910. The data may then be routed to a recipient device via inter-cloud switch 915. The switch 915 may direct the data to the correct recipient, for example in any of networks 920, 921, without storing or accessing the encrypted data. In this way, the data may be more secure, such that the encrypted data is not accessible via the switch 915. This may further isolate the service 110 from information breaches. In a similar way, encrypted data may be communicated within a network 920, 921 without the data being stored in route to a recipient device.

FIG. 10A illustrates an example system and process 1000 for transmitting data using the described obfuscation techniques from a client device 105 already associated with service 110 to a second device 505 not associated with service 110. As illustrated, client device 105 may be associated with a local or client network 1010, which may include other devices, servers, etc., such as a client server 860, which may be connected via communication link 1015. The client device 105 may also be in communication with a service switch 915, which may be co-located with client device 105/client network 1010. Via the switch 915, the client device 105 may authenticate and receive a first encryption seed for encrypting data to send to a recipient device, such as second device 505.

In one example, a user of client device 105 may access the service 110 via a website associated with the service. To initialize the service 110, the user of the client device 105 may download a subscription agreement. The download may trigger some sort of user or licensing agreement, such as a EULA (“End User's Licensing Agreement”) to be displayed on the screen of the device 105. In one aspect, the license agreement may be downloaded in a container that also contains an initial seed, with or without a QGN, for example, as embedded script in the container. The initial seed may be particular to the license agreement/download instance to prevent unwanted interception and use of the initial seed.

Once the user or subscriber accepts the terms of the agreement or license, the embedded script may send a request to establish a first-time secure connection between the client device 105 and the service 110/authentication server 805, for example via the switch 915 over communication link 1035. In some aspects, the request may be sent to the service 110, which upon receipt, may trigger the service 110 to search information stored on or associated with the authentication server 805 to determine if the user/client device 105 is already registered with the service 110. If the user/client device 105 is determined to be a first-time user (e.g., no entry is found containing corresponding identification information of the user or client device 105), then an entry or account may be created in, for example, a user database associated with the authentication server 805 to be used to identify the user/client device. The entry may be created based on data relating to one or multiple of the multiform factor authentication techniques described above, such as password authentication (all platforms), physical authentication (MAC address, IP Address, GPS coordinates, smart card, key fob, etc.), and biometric authentication (iris/retina recognition, fingerprint/finger geometry recognition, face recognition, voice recognition, gait recognition, hand recognition, odor recognition/Olfactory information, signature recognition, typing recognition, vein recognition, etc.). The multiform factor information may be communicated to the service 110 via link 1035, using the initial seed provided with the license agreement, so that no plain text is exchanged between the service 110 and the client device 105, thus reducing the possibility of a security breach. If identification information of the user/client device 105 is found in the user database, then the authentication server 805 may compare the stored information with information submitted by the client device 105 to compare the authentication process. In examples where the user is registered and can be associated with multiple devices, a new device may be added (at any time) to the user account via similar processes as described above. In some aspects, the identification information may be sent to the service 110 when or in response to the user selecting an agreement option to the terms/license.

In some aspects, authentication may include verification, for example, qualification and quantification (QnQ) of environmental values specifically unique to the client device 105/switch 915 and server 805 at a given location and at a given point in time. Authentication may also include validation, for example, verification of an indisputable uniqueness of a value that has been stamped with a Quasi Quantum Randomly Generated Number Stamp (QQRGNS). Each use of the client application may be a unique instance of disposable code. This may protect another instance of the client application/another device from submitting identical credentials from an identically cloned device. A perfectly cloned device may be detected by a simple challenge and response, such as a randomized question supplied by 3^{rd} party providers (e.g., “Have you ever owned this car, have you ever lived at this address, etc.). This industry standard method of verifying questionable use of credit card or personal financial information along with requiring verification that the user possesses information on his person that is not on the device being used as a whole may further ensure security of the data to be encrypted.

In some aspects, each use of the client application (e.g., download or upload of a file or attachment) may use the same user encryption pad or seed, but may move the starting point, for example according to the step value associated with the seed, or may change both the start value and step value. These values may be recorded, for example, in a transaction log associated with the client device. A transaction log may be used to recover any data at rest or stored data (the seeds necessary to decrypt data stored at potentially any location). In some aspects, a username and password scheme may additionally be used. In some cases, other authentication schemes may be similarly utilized to add an additional layer of security, such as based on smart cards, credit card with chips and/or other separate devices or personal objects (e.g., jewelry). This object-type layer of security may further thwart against a cloned device successfully accessing data, for example, based on the randomness of the user's preferences on selecting which of various media or objects are used. Additionally or alternatively, other forms of security and passcodes may be sent via other means, such as physical means (e.g., mail) or via other communication channels.

In one example, the additional layer of security may include verifying one or more environmental values, such as any number of RFID/NFC chips that can reside in a subscriber's possessions (e.g., various personal and/or electronic items including wallets, purses, briefcases, etc.) as well as the obfuscated or encrypted values based on or derived from credit/debit cards, Driver's Licenses, Passports, combinations thereof, etc. In some instances, RFID/NFC values, and/or values based on physical objects, may be combined or obfuscated by various means to create one or more environmental values. In one example, service 110 may communicate, read, write or modify, and/or replace seeds or values associated with devices including re-writable RFID and NFC chips. In some aspects, the modified RFID or NFC values may then be used to generate one or more environmental values, for example, after a potential security breach (e.g., someone accessing, attempting to access, or believed to have attempted access or accessed the RFID or NFC value).

In some aspects, multiple environmental values or identifiers, which may be alpha-numeric, and/or contain other symbols, etc., may be used to further increase security and thwart cloned devices from gaining access to encrypted data. In some aspects, multiple environmental values may be obtained/generated and associated with a user device 105, 505/user account, and subsequently a subset of the already obtained/generated values may then be combined at random or based on a variety of algorithms to generate a combined environmental value, which may include a one-time use environmental value for validation/authentication. One or more of these measures may be combined to further enhance security. In some cases, a security breach by a cloned device may be further thwarted by pinging, by the service 110, the client device 105 and/or a second device 505, periodically, at some specified interval, at random times, etc. In some aspects, the process of pinging the client device 105, 505 may be performed at a low bit rate and may employ a simple daemon process. Upon detection of an echo, such as a response from a cloned device, further encryption and/or authentication may be implemented, including locking communications with both the client device 105, 505 and the cloned device and requiring the user of the client device 105, 505 to call into a support provider and provide authentication credentials, in order to unlock communications with the service/encrypted data. In one example, the pinging process may include the following steps:
1. Ping the client device frequently or constantly.
2. Detect a second response indicating a cloned device (echo).
3. Trigger challenge and response protocol to client device (challenge and responses may be selected/configured upon first registration of the account).
4. In some cases, notify external authority of cloned device.

In some cases, the client device 105, 505 may power down for any of a variety of reasons during the pinging process, and a cloned device may assume the role of the client device 105. In this circumstance, an interruption or timing difference in the responses may be detected, and in response the service 110 may pause or stop transmitting to the client device. Upon reconnection with the client device 105, 505, the service may change one or more parameters for communication with the client device 105, 505 to prevent the cloned device from accessing communicated data (e.g., of the client application, one or more encryptions pads or seed, etc.). Additionally or alternatively, upon detection of a timing irregularity, a challenge/response protocol may be triggered, to verify the true identity of the client device 105, 505. In similar cases, any change in a power cycle of the client device 105, 505, and/or detection of an irregularity in the power cycle, for example, of a cloned device, may trigger a challenge response protocol. In some cases, a counter may keep track of the number of times each specific challenge is used, for example, to minimize repetition, to prevent a security breach based on a given pattern or number of uses, etc. Any of the above techniques may also be used to detect and thwart a cloned device from access secure data, for example, where the client device 105, 505 is disabled, such as by a hacker.

If there is a missed or irregular response received by the service 110, the client device 105, 505, may be presented with a challenge/response protocol based on questions that were answered at registration of the user/client device 105, 505, and/or biometric data that was obtained. In one example, presenting 2 challenges out of a total of 12 configured challenges yields a possible 132 permutations, meaning the hacker has only a 1:132 or 0.75% chance of guessing the correct questions ahead of time based on simple probability of permutations n!/((n!−r!)) where n=12 and r=2. Regardless of being able to guess the questions, the correct responses and/or biometrics would also have to be produced to pass through the challenge/response protocol, making it extremely unlikely that a cloned device could successful pass as the intended client device 105, 505. In some examples, regardless of the manner that a hacker attempts to subvert the connection of the client device 105, 505, the cloned device will have to go through a handshake with the service 110 upon attempting to connect, which will trigger another challenge.

Once a user/client device 105 has been authenticated with the service 110/authentication server 805, an option for a level of security, e.g., a level or complexity of encryption may be provided to the client device 105, such as according to a Good, Better, Best scheme. A selection of a “good” level of security may include following standard Internet practices, such as using any available 2-form factor authentication. An example of a “good” security level implementation may include the service 110 sending the user an SMS text message containing a unicode string of a randomly generated length+strength associated with a level of difficulty, for example, in accordance with the selection of the “good” level security. Upon entering the unicode string, for example, in an HTTPS message box triggered by the sender's selection of a good, better, best, the security code may now be recognized as a form factor. It should be noted, that any commonly used form factor may be used, as communications, and in some case all communications, between the client device 105 and service are encrypted, and not sent as plain text, thus reducing the likelihood of a security breach.

A selection of a “better” level of security may include requesting or requiring an affirmative selection to be made by a recipient of the secure data and transmitting the affirmative selection back to the sender or user device 105 before transmitting the encrypted data. The affirmative selection may take the form of clicking an “I accept:” pop-up or message box, for example by the second device 505.

A selection of a “best” level of security may include an authentication token being randomly generated by a Quasi QUANTUM RNG (e.g., RNG 135) and divided between the devices 105, 505 participating in the establishment of the requested secure connection. Each user of device 105, 505 may be requested or prompted to enter the token (e.g., in some cases, accomplished by a selection event), in some cases, simultaneously or concurrently. It should be appreciated that the above described techniques may be implemented with any number of devices 105, 505. It should also be appreciated that other types, other implementations, and other numbers of data encryption standards or levels may be implemented without going beyond the scope of this disclosure.

According to the above-described techniques, the client device 105 may authenticate and select a level of data encryption or security to be associated with a future communication, for example, with second device 505. The client device 105, before, concurrently with, or after authenticating with service 110, may send a request to the second device 505 to register with the service 110/authenticate with the service 110 to enable the device 505 to receive an encrypted message or messages from client device 105. In some cases, this may be effectuated via direct communications with the second device 505, for example, via communication link 1005, or through the service 110, such as via routing server 810 over communication link 1025 (using or not using the encryption techniques described above). The routing server 810 may then send an indication of the requested communication from client device 105 to device 505 via communication link 1055.

In either of the above examples, the second device 505 may then request and obtain an installation file to install a service application from the service 110 via link 1055 at operation 1040. In some cases, the installation file and/or application may include a temporary installation, such that upon reception of encrypted data (e.g., which may be configured by the sending device 105), the application may in essence stop operation or delete itself. Using the installed application, the second device 505 may register/perform authentication with the authentication server 805 via link 1060 at operation 1045, is a similar way as described above for client device 105.

In some aspects, the service application may include self-compiling code defining a shell program 1065, as illustrated in diagram 1000b of FIG. 10B, that requires device specific values and multiple QGN seeds to initialize/install. In some aspects, the shell program 1065 may be polymorphic and may be both multi-level and multi-dimensional, for example, including a socket file transfer layer 1066, a multi-process monitor 1068, ad a process replicator 1070. In one example, three or more separate physical devices may be used to enable access/generation of an initial seed to be used with the application.

FIG. 10C illustrates an example of a seed process 1000c, which may be performed by client device 105, service 110, and or second device 505. The second device 505 may initialize installation a client application, for example at operation 1040 of FIG. 10A. A shell program 1065 may be initialized on the second device 505 and may request a public seed from the public aspect 1072 of service 110 at operation 1074. The public seed may contain or include a unique request identifier, for example, that may be generated by QNG 1076, which may be an example of RNG 135. Next, the unique request identifier generated on public side 1072 may be passed to the private side 1078 of service 110 at operation 1080, to obtain a private seed. In some aspects, to further increase security, operation 1080 may be performed over a hardwired communication link and/or may be encrypted. The public seed, generated by the QNG 1076, may then be inserted into the shell program and compiled. Next, the shell program 1065 may obtain the private seed at operation 1082, which may include the start and step values associated with the public seed. The shell program 1065 may then compile the start value and step values. The shell program 1065 may request and obtain from the second device 505 (or in some cases, client device 105), a number of device specific values 1084. Upon receiving the device specific values 1084, and in some cases, further authentication information, such as username and password, the shell program 1065/client application may execute and enable access to encryption services 110 via second client device 505.

Upon completion of authentication, the client device 105 may send encrypted data of files, using seeds generated and received from the service 110, to second device 505 via link 1005 at operation 1050. In one aspect, the second device 505 may receive the seed(s) from the service 110, encrypted with an instance or device specific seed. The second device may use the received seed(s) to decrypt the received data or files from the client device 105. In other aspects, the client device 105 may send the encrypted data through the routing server 810 to the second device 505. In some aspects, the routing server 810 may decrypt and then re-encrypt the data with seed(s) unique to the second device 505. In some examples, the routing server 810 may send the encrypted data using the seed(s) utilized by the client device 105, so as to decrease the time required to transmit the encrypted data to the second device 505. It should be appreciated that the encrypted data may be sent directly to the second device 505 or to the service 110 at any time after the client device 105 has received one or more seeds from the service 110. For example, the client device may transmit encrypted data at operation 1050 to the second device 505 before the device 505 has downloaded and installed the service application or completed authentication. In some cases, sending of the encrypted data itself may operate as an indication to the device 505 to register/authenticate with service 110. In some cases, the message/encrypted data may include a link or other instructions (un-encrypted) directing the user of device 505 to register with service 110.

At any time during process 1000 described above, if a discrepancy is found between user or device credentials, and information associated with that user or device in the service 110, the user/device may be denied access to the service 110. In some aspects, upon detection of such a discrepancy, for example, associated with a recipient of an encrypted message, the sender device may be notified and given an opportunity to override the discrepancy and allow the encrypted data to be accessed by the recipient, for example via a temporary password type scheme. In some examples, if an attempt to decrypt the data is unsuccessful the service or application running on a the device 105, 505, may implement further protection measures to further obfuscate the data, including adding one or roe layers of encryption to the already encrypted data (e.g., via using the same seed with different start and step values, requesting a new seed from service 110, etc.). In some aspects, further protection measures may be linked to a location of the encrypted data, for example associated with a device 105, 505.

In some cases, in the process of encrypting data to be sent to a recipient, such as device 505, the user of client device 105 may select an option to be notified when the data is accessed or attempted to be accessed.

In some aspects, authentication of a user/client device 105, 505, may additionally or alternatively include authentication or affirmation by another device also registered or otherwise associated with service 110. In some cases, identification or multiform factor information associated with a user/account may include environmental values, such as location, schedule, history logs, network topologies (user, device, and environmental values of other devices on local network), etc. By requiring validation of one or more environmental values in addition to the multiform factor information described above (e.g., creating a multi-table identification or entry system), authenticating with the service 110 may be made more complex, to further prevent unwanted access. In some cases, the additional layer of validation may require authentication with a super user, or user who has already been authenticated with another user and the service 110. In some examples, two or more super users may be required to authenticate a new user.

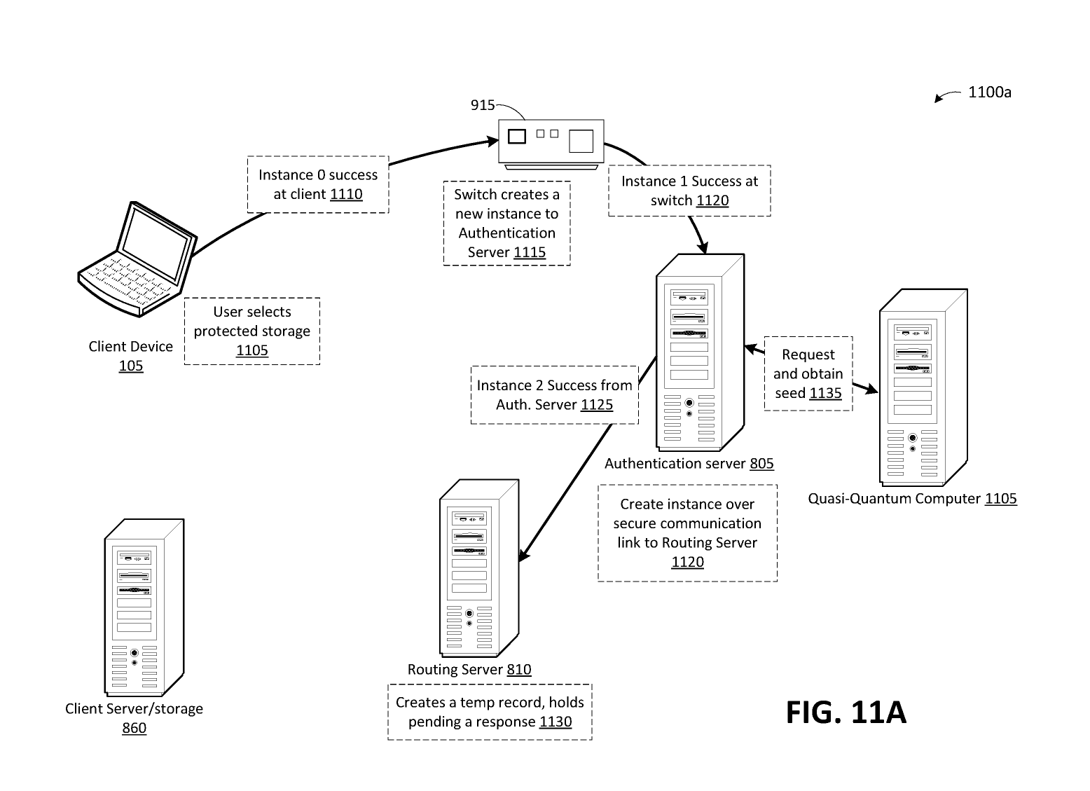

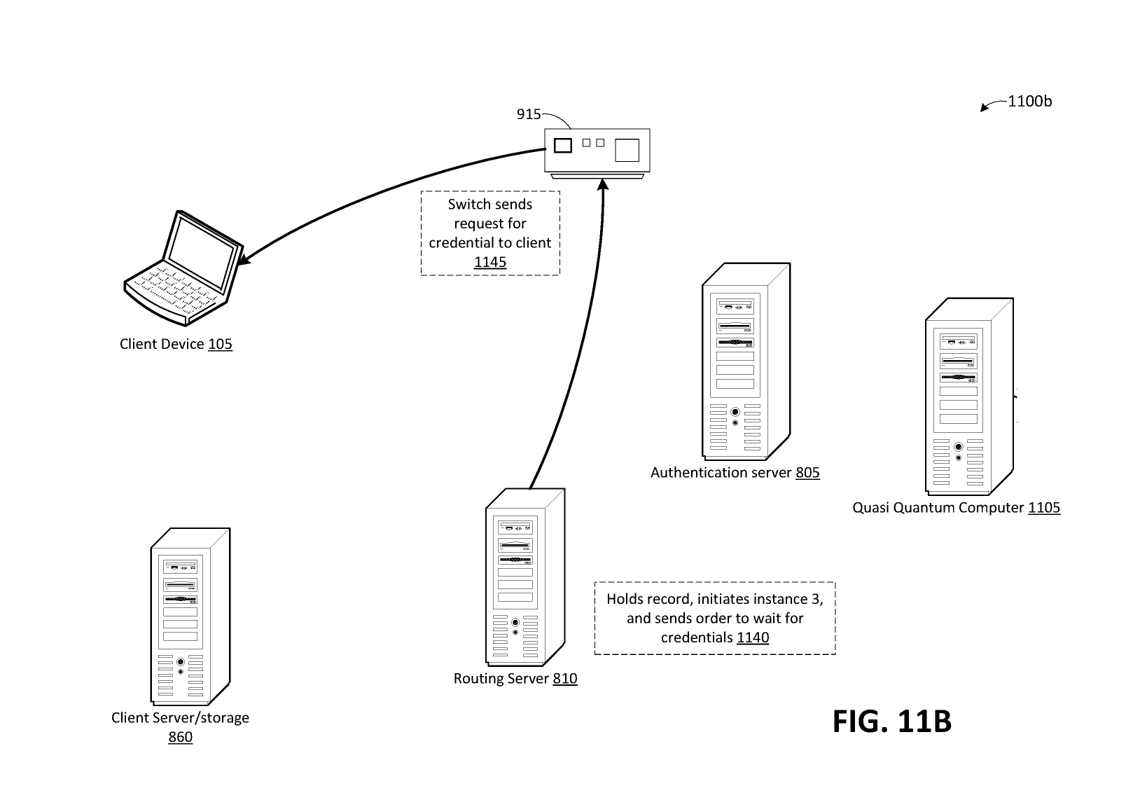

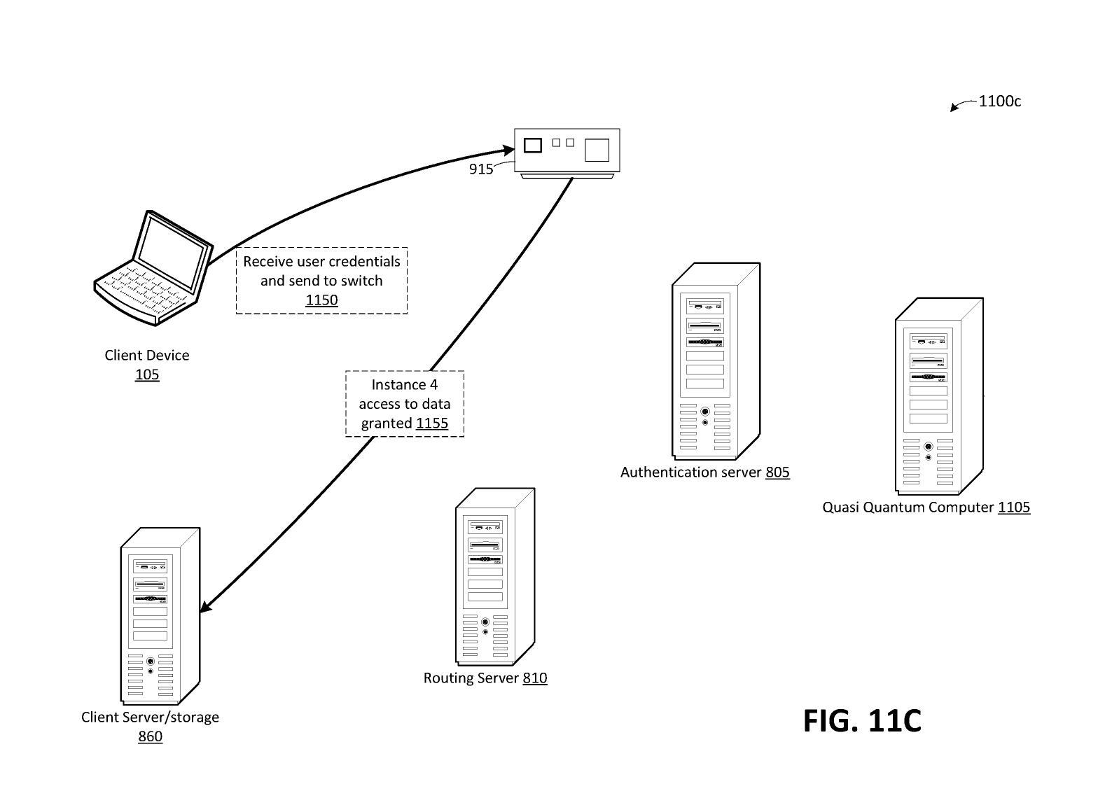

FIGS. 11A, 11B, and 11C illustrate a process for accessing encrypted data from a client server 860, for example, by client device 105, using the encryption systems and service 110 described above. As illustrated by diagram 1100a of FIG. 11A, a client device 105 may receive a selection or option for protected storage at operation 1105. The client device 105 may connect to switch or component 915, for example, to facilitate establishing a secure communication link with service 110, which may include authentication server 810 routing server 810, and quasi-quantum computer 1105. Upon successful communication establishment with switch 915 at operation 1110, the switch may create a new secure communication instance with the authentication server 805 at operation 1115. Upon successful communication with authentication server 805 at operation 1120, the authentication server 805 may create a new instance over a secure communication link with routing server 810 at operation 1120. In some aspects this may include requesting and obtaining from the quasi-quantum computer 1115 a first, and in due course, subsequent unique seeds for data obfuscation at operation 1135. Upon successful communication link establishment with routing server 810 at operation 1125, the routing server 810 may create and hold a temporary record or entry associated with the user/client device 105 at operation 1130.

As illustrated in diagram 1100b of FIG. 11B, the routing server 810, while holding the recently created record at operation 1130, may initiate an instance or session with client device 105 and send an order or indication (e.g., to switch 915 and/or authentication server 805), to wait for credentials or identification information from the user/client device 105 at operation 1140. The switch 915, upon receiving the order from the routing server 810, may send a request for credentials to the client device 105 at operation 1145.

As illustrated in diagram 1100c of FIG. 11C, the client device 105 may display the request received from switch 915 and provide a user interface to a user to display the request for information. The request may include a request for login credentials, biometric information, and the like. The client device 105 may receive the credentials at operation 1150 and send the credentials to switch 915. In some cases, the switch 915 may obtain the user entry from the authentication server 805, such that it may verify and grant access to the client server 860 if the credentials match the user entry or record. In this case, access may then be granted to the client device 105 to access and manipulate encrypted data soured in the client server/storage 860 at operation 1155.

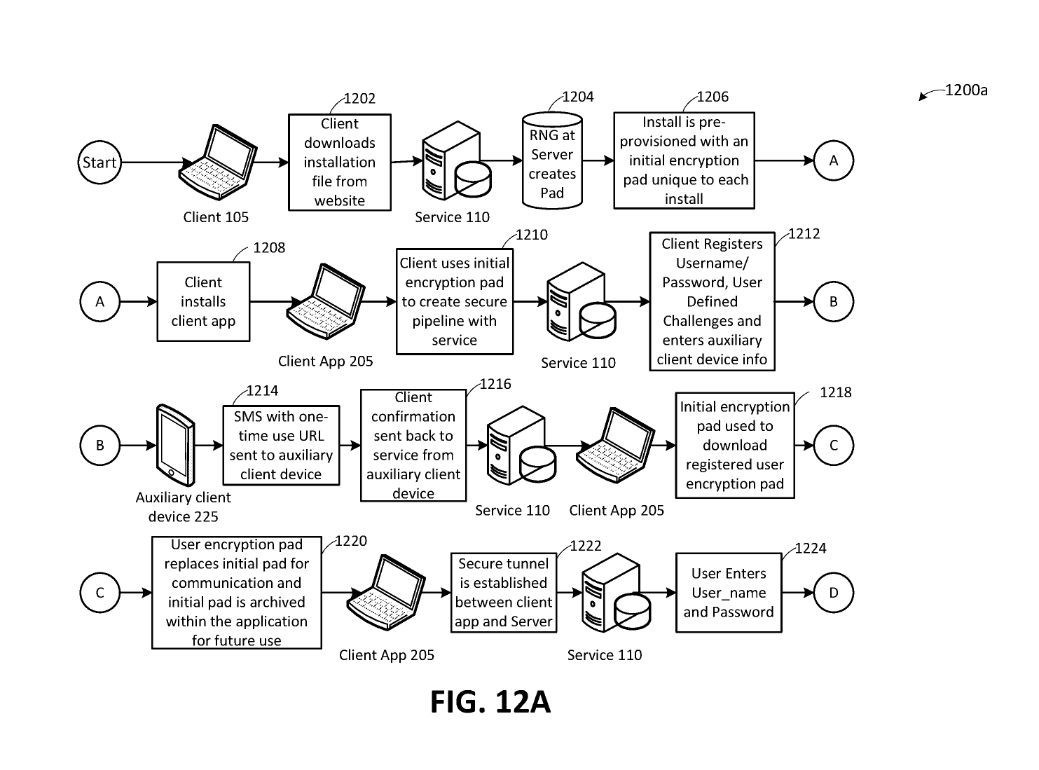

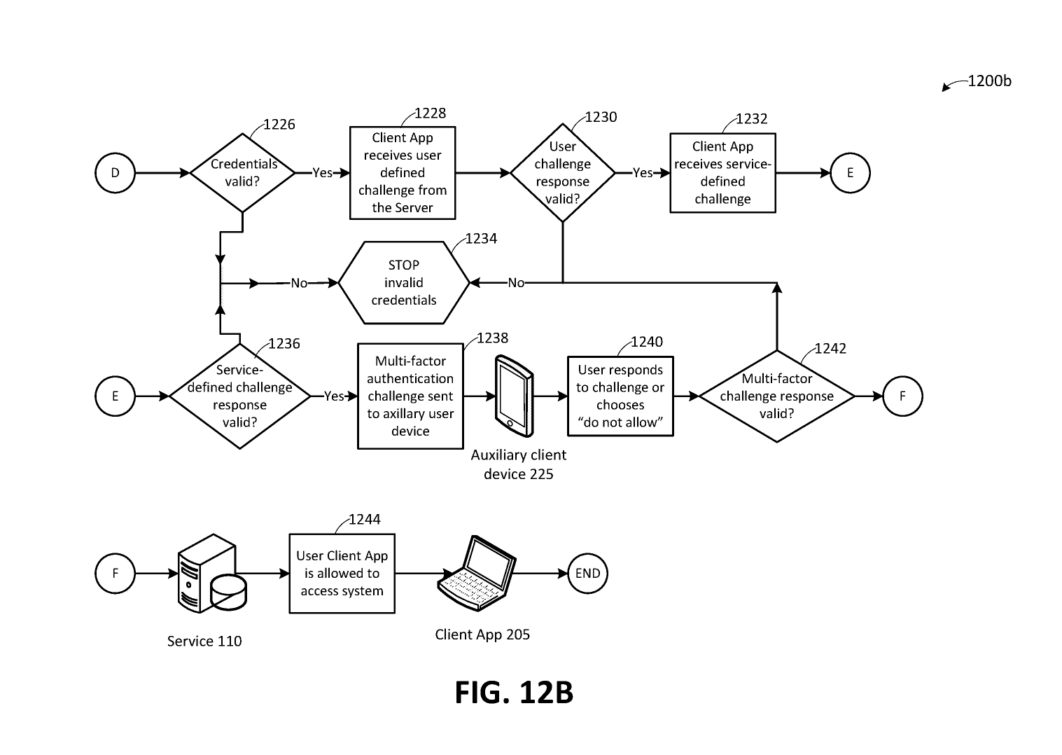

FIGS. 12A and 12B depict a specific example process 1200 for registering a client device 105 with the service 110, according to the techniques described herein. As will be described below, process 1200, broken into processes 1200a and 1200b, may be performed by the client device 105 and the service 110, for example using seed 300 as described above in reference to previous FIGs.

Process 1200 may start with a client or client device 105 downloading an installation file from a website associated with an encryption service at operation 1202. A RNG, such as RNG 125, associated with the service 110 may create, either concurrently with or before operation 1202, an initial seed to associate with the installation file at operation 1204. The service 110 may pre-provision the installation file with the seed unique to a particular installation file at operation 1206. The client 105, upon downloading the installation file, may install a client application, such as client application 205, onto the client 105 at operation 1208. The client 105 may subsequently, via the client application 205, use the initial seed to create a secure communication link or pipeline with the service 110, at operation 1210. The client 105 may register a username, password, one or more user-defined challenges and auxiliary client device 225 information, at operation 1212, by communicating the data encrypted by the initial seed over the secured pipeline.

The auxiliary client device 225 may receive, for example, a SMS message with a one-time use URL, at operation 1214, as a second form of authentication. The auxiliary client device 225 may transmit a confirmation of receipt of the one-time use URL at operation 1216. This may include, for example, receiving, at the auxiliary user device 225, a selection of the one-time use URL. Upon selection, a confirmation may be automatically transmitted back to the service 110. Upon receipt of the one-time use URL selection (or other secondary form of authentication), the service 110 may generate and make available a user-specific unique seed, for example, enabling the client 105 to download the user seed using the initial seed, at operation 1218. The client 105 may archive the initial seed (e.g., for later recovery purposes if needed), and use the user seed for subsequent communications with the service 110, at operation 1220. A secure tunnel, e.g., for dedicated and future use of the service 110, may be established for the client 105, at operation 1222.

In order to begin using the service 110, the client device 105 may receive and submit a user name and password to the service 110, at operation 1224. The service 110 may verify if the credentials are valid at operation 1226. If not, process 1200 proceeds to operation 1234, where the process is ended. In some aspects, one or possibly more failed attempts may result in another chance for the user associated with the client 105 to enter valid credentials. The number of re-tries for correct entry of credentials may be configurable, for example, based on security concerns, length of a required username/password, etc. If the credential information is validated at operation 1226, the client application 205/client 205 may receive a user-defined challenge from the service 110 at operation 1228. The client 105/client application 205 may transmit the user-entered response to the service 110. The service 110 may subsequently determine if the response is valid at operation 1230. If no valid response is received, the service 110 may terminate the process at operation 1234. If the response is valid, the client application 205 may receive a service-defined challenge at operation 1232.

The service 110 may determine if the response to the service-defined challenge is valid at operation 1236. If no valid response is received, the service 110 may terminate the process at operation 1234. However, if a valid response is received at operation 1236, the service 110 may then send a multi-factor authentication challenge to the auxiliary user device 225 defined in the registration/credential information. If a false attempt is made to access the system, the owner of the user axillary device 225 may choose a “do not allow” option to prevent an unwanted party from using the user's account, at operation 1240. If the user does wish to proceed using the service 110, the user may enter a response at operation 1240. If the response is not valid, as determined by the service 110 at operation 1242, the process may terminate at operation 1234. However, if the response is valid, the client is allowed to access the client application 205 and communicate information using unique seeds generated by the service at operation 1244. At the conclusion of desired communications, process 1200 may end.

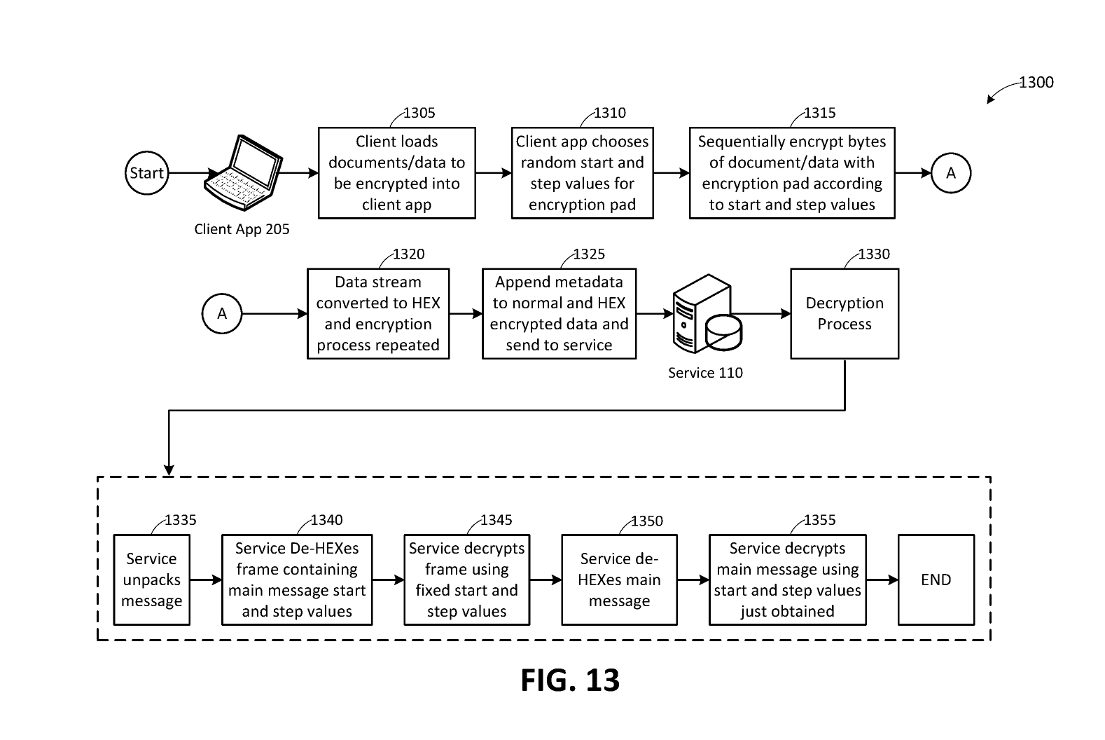

FIG. 13 illustrates an example process 1300 for sending and subsequently decrypting a file or other data/message encrypted using the processes described above. As will be described below, process 1300 may be performed by the client device 105/client application 205 on client device 105 and the service 110, for example, using seed 300, as described above in reference to previous FIGS.

Process 1300 may start with the client application 205 receiving/loading documents, files, data, etc., to be encrypted at operation 1305. The client application 205 may select a random start date and a random step value for encryption to be used with a unique seed at operation 1310. In other aspects, these values, e.g., the random number or QGN, may be determined by the service 110 and communicated to the client 105/client application 205. The client application 205 may then sequentially encrypt bytes of data with the seed according to the generated start and step values at operation 1315. The data stream (e.g., the encrypted data), may be converted to HEX and the encryption process (e.g., operations 1305 through 1315) may be repeated to offer an additional level of security, at operation 1320, by the client application 205. Metadata may then be appended to the normal and HEX versions of the encrypted data and transmitted to the service 110 at operation 1325.

The service 110, upon receiving the encrypted data, may begin the decryption process 1330 by first unpacking the message(s) at operation 1335. The service 110 may de-HEX the frame or portion containing the main message start and step values (e.g., the main message random number or QGN), at operation 1340. The service 110 may then decrypt the frame containing the random number or QGN using the fixed or predetermined start and step values (e.g., associated with a user-specific seed) at operation 1345. The service 110 may de-HEX the main message at operation 1350 and decrypt the main message using the recently obtained start and step values (e.g., the main message random number or QGN) at operation 1355. Once the entire message or all of the messages are received and decrypted, process 1300 may end.

It should be appreciated that processes 800 and 1300, however described between a client device 105 and a service 110, may be easily applied and modified to enable communication, including encryption decryption of data, to multiple user or other devices. For example, processes 800 and 1300 may be utilized to relay data from a first device 105 to the service 110, and then from the service 110 to a second device 505, as described in reference to FIGS. 5 and 6 above. Additionally or alternatively, processes 800 and 1300 may be modified so that some or all of the operations may be performed between or by two devices 105, 505, using the service to initialize the encryption process and/or to provide subsequent seeds.

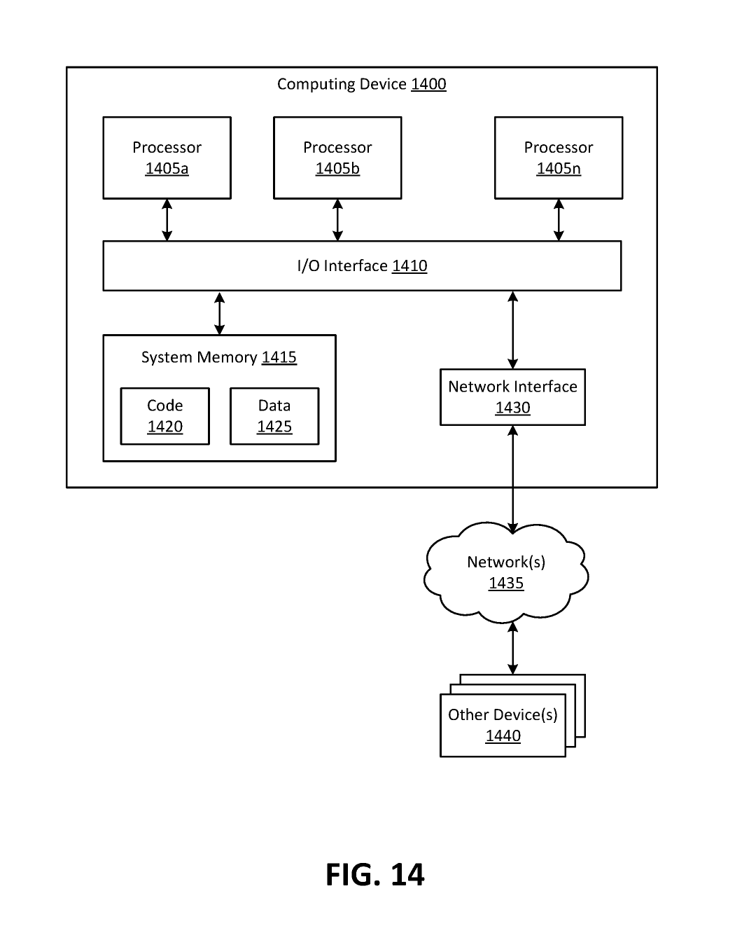

In at least some embodiments, the techniques described herein for establishing a secure communication link between a client device 105 and a service 110/a second device 505 may be implemented on one or more computing devices 1400. FIG. 14 depicts an example of a general-purpose computer system including a computing device 1400 in communication with other devices 1440, which may include client device 145, service 110, and/or second device 505, which is configured for securely communicating data via encryption in accordance with various embodiments described herein. In some aspects, the service 110 may be provided on one or more servers, which may incorporate some or all aspects of computing device 1400. The service 110 may additionally or alternatively be provided by one or more virtual machine instances, including processing and memory capabilities not hosted on a particular device, but utilizing designated or reserved hardware resources over a network.

In the illustrated embodiment, computing device 1400, which may incorporate aspects of client device 145, service 110, or second device 505, includes one or more processors 1405a, 1405b through 1405n coupled to a system memory 1415 via an input/output (I/O) interface 1410. Computing device 1400 further includes a network interface 1430 coupled to the I/O interface 1410, by which computing device 1400 may communicate with other devices 1440.

In various embodiments, computing device 1400 may be a uniprocessor system including one processor 1405 or a multiprocessor system including several processors 1405. Processors 1405 may be any suitable processors capable of executing instructions. For example, in various embodiments, processors 1405 may be general-purpose or embedded processors implementing any of a variety of instruction set architectures (ISAs), such as the x106, PowerPC, SPARC or MIPS ISAs or any other suitable ISA.

System memory 1415 may be configured to store instructions and data accessible by processor(s) 1405. In various embodiments, system memory 1415 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 1415 as code 1420 and data 1425.

In one embodiment, I/O interface 1410 may be configured to coordinate I/O traffic between processor 1405, system memory 1415 and any peripherals in the device, including network interface 1430 or other peripheral interfaces. In some embodiments, I/O interface 1410 may perform any necessary protocol, timing or other data transformations to convert data signals from one component (e.g., system memory 1415) into a format suitable for use by another component (e.g., processor 1405). In some embodiments, I/O interface 1410 may include support for devices attached through various types of peripheral buses, such as a variant of the Peripheral Component Interconnect (PCI) bus standard or the Universal Serial Bus (USB) standard, for example. Also, in some embodiments some or all of the functionality of I/O interface 1410, such as an interface to system memory 1415, may be incorporated directly into processor 1405. In some cases, the I/O interface 1410 may include support for multiple input devices including, random number or QGNboards, touchpads, and the like, and presentation devices including display devices, etc.

Network interface 1430 may be configured to allow data to be exchanged between computing device 1400 and other device or devices 1440 attached to a network or networks 1435, such as other computer systems or devices, for example. In various embodiments, network interface 1430 may support communication via any suitable wired or wireless general data networks, such as types of Ethernet networks, for example. Additionally, network interface 1430 may support communication via telecommunications/telephony networks such as analog voice networks or via any other suitable type of network and/or protocol.

In some embodiments, system memory 1415 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1400 via I/O interface 1410. A non-transitory computer-accessible storage medium may also include any volatile or non-volatile media such as RAM (e.g. SDRAM, DDR SDRAM, RDRAM, SRAM, etc.), ROM (read only memory) etc., that may be included in some embodiments of computing device 1400 as system memory 1415 or another type of memory. Further, a computer-accessible medium may include transmission media or signals such as electrical, electromagnetic or digital signals conveyed via a communication medium such as a network and/or a wireless link, such as those that may be implemented via network interface 1430. Portions or all of the computing device 1400 and/or portions or all of other devices 1440 illustrated in FIG. 14 may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage, such as, e.g., volatile or non-volatile storage.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed:

1. A system for establishing a secure communication link comprising:
a service in communication with a user device, the service comprising:
a hardware random number generator configured to generate at least one first unique encryption pad including a key comprising a first randomly selected start value and a first randomly selected step value;
one or more processors communicatively coupled to the hardware random number generator; and
one or more memories having stored thereon computer-executable instructions that, upon execution, cause the service to perform operations comprising:
authenticating the user device using an initial unique encryption pad generated by the service;
encrypting the first unique encryption pad and the key with the unique initial encryption pad upon authentication of the user device;
communicating the encrypted first unique encryption pad and the encrypted key to the user device; and
establishing the secure communication link with the user device, wherein data communicated over the secure communication link is encrypted by the at least one first unique encryption pad.

2. The system of claim 1, wherein the at least one first unique encryption pad comprises a first unique encryption pad and a second unique encryption pad, wherein the second unique encryption pad is encrypted by the first unique encryption pad, and wherein at least part of the second unique encryption pad is communicated to the user device over the secure communication link upon use of a portion of the first unique encryption pad to encrypt the data.

3. The system of claim 1, wherein the instructions for authenticating the user device further comprise instructions for:
registering the user device, wherein registering comprises:
receiving one or more credentials encrypted with the initial unique encryption pad, the one or more credentials comprising at least one of a user name, a password, a user-defined challenge answer, or a service-defined challenge answer, or a one-time use URL;
associating the one or more credentials with the user device.

4. The system of claim 3, wherein the encrypted one or more credentials comprise the user name and password, wherein the instructions for registering further comprise instructions for:
transmitting a one-time URL to the user device using a communication link other than the secure communication link in response to verifying the user name and password; and
receiving an indication that the user device has accessed the one-time URL.

5. The system of claim 1, further comprising a second user device in communication with the service, wherein the hardware random number generator is further configured to generate at least one second unique encryption pad including a second key comprising a second randomly selected start value and a second randomly selected step value, and wherein the instructions cause the service to perform operations comprising:
authenticating the second user device using a second initial unique encryption pad generated by the service;
encrypting the second unique encryption pad and the second key with the second unique initial encryption pad upon authentication of the second user device;
communicating the encrypted first unique encryption pad and the encrypted key to the second user device; and
establishing a second secure communication link between the service and the second user device, wherein communications communicated over the second secure communication link are encrypted by the at least one second unique encryption pad.

6. A method for securely communicating data comprising:
authenticating a user device, by a service, using an initial unique encryption pad generated by the service;
generating at least one first unique encryption pad including a key comprising a first randomly selected start value and a first randomly selected step value;
encrypting the first unique encryption pad and the key with the unique initial encryption pad upon authentication of the user device;
communicating the encrypted first unique encryption pad and the encrypted key to the user device; and
establishing a secure communication link with the user device, wherein data communicated over the secure communication link is encrypted by the at least one first unique encryption pad.

7. The method of claim 6, wherein the at least one first unique encryption pad comprises a first unique encryption pad and a second unique encryption pad, and wherein the second unique encryption pad is encrypted by the first unique encryption pad and communicated to the user device over the secure communication link.

8. The method of claim 7, wherein the second unique encryption pad is communicated to the user device over the secure communication link upon occurrence of a trigger event.

9. The method of claim 6, wherein establishing the secure communication link with the user device further comprises:
establishing a first communication tunnel configured for transfer of data; and
establishing a second communication tunnel configured for communication of one or more of the at least one first unique encryption pad.

10. The method of claim 6, wherein authenticating the user device using the initial unique encryption pad further comprises:
receiving, from the user device, one or more credentials encrypted by the initial unique encryption pad, the one or more credentials comprising at least one of a user name, a password, a user-defined challenge answer, a service-defined challenge answer, or a one-time use URL; and
verifying the one or more credentials by accessing credential information stored by the service.

11. The method of claim 6, wherein authenticating the user device further comprises:
registering the user device, wherein registering comprises:
receiving one or more credentials encrypted with the initial unique encryption pad, the one or more credentials comprising at least one of a user name, a password, a user-defined challenge answer, a service-defined challenge answer, or a one-time use URL; and
associating the one or more credentials with the user device.

12. The method of claim 11, wherein the encrypted one or more credentials comprise the user name and password, wherein registering the user device further comprises:
transmitting a one-time URL to the user device using a communication link other than the secure communication link in response to verifying the user name and password; and
receiving an indication that the user device has accessed the one-time URL.

13. The method of claim 6, wherein authenticating the user device further comprises:
initially providing the initial unique encryption pad to the user device for download;
transmitting a user unique encryption pad to the user device using the initial unique encryption pad upon receiving the unique initial encryption pad, wherein authentication is performed using the user unique encryption pad.

14. The method of claim 13, further comprising registering and authenticating a second user device associated with the one or more credentials using the user unique encryption pad.

15. The method of claim 6, further comprising
generating at least one second unique encryption pad including a second key comprising a second randomly selected start value and a second randomly selected step value
authenticating a second user device using a second initial unique encryption pad generated by the service;
encrypting the second unique encryption pad and the second key with the second unique initial encryption pad upon authentication of the second user device;
communicating the encrypted second unique encryption pad and the encrypted second key to the second user device; and
establishing a second secure communication link between the service and the second user device, wherein data communicated over the second secure communication link is encrypted by the at least one second unique encryption pad.

16. The method of claim 15, further comprising:
establishing a third secure communication link for transferring the data between the user device and the second user device, wherein the data communicated over the third secure communication link is encrypted by the at least one first unique encryption pad or the at least one second unique encryption pad.

17. The method of claim 16, further comprising:
receiving a request from at least one of the user device or the second user device for another of the at least one first or second unique encryption pads;
generating, based on the request, at least one third unique encryption pad including a third key comprising a third randomly selected start value and a third randomly selected step value;
encrypting the third unique encryption pad and the third key with the at least one of the first unique initial encryption pad, the second unique initial encryption pad, the at least one first encryption pad, or the at least one second unique encryption pad; and
communicating the encrypted third unique encryption pad and the encrypted third key to at least one of the user device or the second user device.

18. The method of claim 6, further comprising:
cycling through a number of bytes of the first unique encryption pad to encrypt the data; and
associating a second key including a second randomly selected start value and a second randomly selected step value to the first unique encryption pad.

19. The method of claim 6, wherein the at least one of the at least one first unique encryption pad and the initial unique encryption is generated by a hardware random number generator, and wherein the at least one first unique encryption pad comprises a number of bytes, wherein the number of bytes is a prime number.

20. One or more non-transitory computer-readable storage media having stored thereon instructions that, upon execution on at least one compute node, cause the at least one compute node to perform operations comprising:
authenticating a user device, by a service, using an initial unique encryption pad generated by the service;
generating at least one first unique encryption pad including a key comprising a first randomly selected start value and a first randomly selected step value;
encrypting the first unique encryption pad and the key with the unique initial encryption pad upon authentication of the user device;
communicating the encrypted first unique encryption pad and the encrypted key to the user device; and
establishing a secure communication link with the user device, wherein data communicated over the secure communication link is encrypted by the at least one first unique encryption pad.
